(19) United States
(12) Patent Application Publication
(10) Pub. No.: US 2026/0025738 A1
(43) Pub. Date: Jan. 22, 2026

(54) COMMUNICATION OF SYSTEM INFORMATION VIA A PHYSICAL DOWNLINK SHARED CHANNEL IN ACCORDANCE WITH INFORMATION PROVIDED BY A MASTER INFORMATION BLOCK

(71) Applicant: QUALCOMM Incorporated, San Diego, CA (US)

(72) Inventors: Mostafa KHOSHNEVISAN, San Diego, CA (US); Yan ZHOU, San Diego, CA (US); Jing JIANG, San Diego, CA (US); Tao LUO, San Diego, CA (US)

(21) Appl. No.: 18/777,309

(22) Filed: Jul. 18, 2024

(51) Int. Cl. H04W 48/10; H04W 72/0446

(52) U.S. Cl. CPC H04W 48/10; H04W 72/0446

(57) ABSTRACT

Methods, systems, and devices for wireless communication are described. Various aspects generally relate to increasing remaining minimum system information (RMSI) physical downlink shared channel (PDSCH) coverage by using one or more physical downlink control channel (PDCCH) resource elements (REs) for the RMSI PDSCH and removing an expectation of a user equipment (UE) to decode an RMSI PDCCH. Some aspects more specifically relate to mechanisms according to which a UE receives information indicative of one or more parameters or resources of an RMSI PDSCH via a mast information block (MIB) or determines one or more parameters or resources of the RMSI PDSCH in accordance with a rule. In some examples, a network entity may transmit an indication of a coding rate of the RMSI PDSCH via the MIB. The UE may decode the RMSI PDSCH for a first system information block (SIB1) in accordance with the indicated coding rate.

### FIELD OF TECHNOLOGY

The following relates to wireless communication, including communication of system information via a physical downlink shared channel (PDSCH) in accordance with information provided by a master information block (MIB).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving, via a physical broadcast channel (PBCH), a master information block (MIB) that indicates one or more communication parameters associated with a network entity and that includes an indication of a coding rate of a system information block (SIB) associated with the network entity and receiving, via a physical downlink shared channel (PDSCH), the SIB in accordance with the coding rate indicated by the MIB.

A UE for wireless communication is described. The UE may include one or more memories storing processor executable code, and one or more processors coupled with the one or more memories. The one or more processors may individually or collectively be operable to execute the code to cause the UE to receive, via a PBCH, a MIB that indicates one or more communication parameters associated with a network entity and that includes an indication of a coding rate of a SIB associated with the network entity and receive, via a PDSCH, the SIB in accordance with the coding rate indicated by the MIB.

Another UE for wireless communication is described. The UE may include means for receiving, via a PBCH, a MIB that indicates one or more communication parameters associated with a network entity and that includes an indication of a coding rate of a SIB associated with the network entity and means for receiving, via a PDSCH, the SIB in accordance with the coding rate indicated by the MIB.

A non-transitory computer-readable medium storing code for wireless communication is described. The code may include instructions executable by one or more processors to receive, via a PBCH, a MIB that indicates one or more communication parameters associated with a network entity and that includes an indication of a coding rate of a SIB associated with the network entity and receive, via a PDSCH, the SIB in accordance with the coding rate indicated by the MIB.

Some examples of the method, UEs, and non-transitory computer-readable medium described herein may further include operations, features, means, or instructions for parsing the MIB in accordance with a synchronization signal block (SSB) multiplexing pattern, where the MIB includes the indication of the coding rate of the SIB in accordance with the SSB multiplexing pattern.

In some examples of the method, UEs, and non-transitory computer-readable medium described herein, the SIB may be received according to a transport block size (TBS) that may be in accordance with the coding rate indicated by the MIB and a resource assignment associated with the SIB.

Some examples of the method, UEs, and non-transitory computer-readable medium described herein may further include operations, features, means, or instructions for receiving the SIB may be in accordance with a time domain resource assignment (TDRA) associated with the SIB and the TDRA may be in accordance with a rule indicative of TDRAs for SIBs of which coding rates may be indicated by MIBs.

Some examples of the method, UEs, and non-transitory computer-readable medium described herein may further include operations, features, means, or instructions for receiving, via the MIB, information indicative of a TDRA associated with the SIB, where the SIB may be received in accordance with the TDRA indicated by the MIB.

Some examples of the method, UEs, and non-transitory computer-readable medium described herein may further include operations, features, means, or instructions for receiving the SIB may be in accordance with a frequency domain resource assignment (FDRA) associated with the SIB and the FDRA may be in accordance with a rule indicative of FDRAs for SIBs of which coding rates may be indicated by MIBs.

Some examples of the method, UEs, and non-transitory computer-readable medium described herein may further include operations, features, means, or instructions for receiving, via the MIB, information indicative of an FDRA associated with the SIB, where the SIB may be received in accordance with the FDRA indicated by the MIB.

In some examples of the method, UEs, and non-transitory computer-readable medium described herein, the UE receives the SIB via the PDSCH without receiving a control message via a physical downlink control channel (PDCCH) that schedules the SIB.

A method for wireless communication by a network entity is described. The method may include outputting, via a PBCH, a MIB that indicates one or more communication parameters associated with the network entity and that includes an indication of a coding rate of a SIB associated with the network entity and outputting, via a PDSCH, the SIB in accordance with the coding rate indicated by the MIB.

A network entity for wireless communication is described. The network entity may include one or more memories storing processor executable code, and one or more processors coupled with the one or more memories. The one or more processors may individually or collectively be operable to execute the code to cause the network entity to output, via a PBCH, a MIB that indicates one or more communication parameters associated with the network entity and that includes an indication of a coding rate of a SIB associated with the network entity and output, via a PDSCH, the SIB in accordance with the coding rate indicated by the MIB.

Another network entity for wireless communication is described. The network entity may include means for outputting, via a PBCH, a MIB that indicates one or more communication parameters associated with the network entity and that includes an indication of a coding rate of a SIB associated with the network entity and means for outputting, via a PDSCH, the SIB in accordance with the coding rate indicated by the MIB.

A non-transitory computer-readable medium storing code for wireless communication is described. The code may include instructions executable by one or more processors to output, via a PBCH, a MIB that indicates one or more communication parameters associated with the network entity and that includes an indication of a coding rate of a SIB associated with the network entity and output, via a PDSCH, the SIB in accordance with the coding rate indicated by the MIB.

In some examples of the method, network entities, and non-transitory computer-readable medium described herein, the indication of the coding rate of the SIB may be included in the MIB in accordance with an SSB multiplexing pattern and the SSB multiplexing pattern may be associated with a frequency division multiplexing of an SSB and the PDSCH.

Some examples of the method, network entities, and non-transitory computer-readable medium described herein may further include operations, features, means, or instructions for outputting the SIB may be in accordance with a TDRA associated with the SIB and the TDRA may be in accordance with a rule indicative of TDRAs for SIBs of which coding rates may be indicated by MIBs.

Some examples of the method, network entities, and non-transitory computer-readable medium described herein may further include operations, features, means, or instructions for outputting, via the MIB, information indicative of a TDRA associated with the SIB, where the SIB may be output in accordance with the TDRA indicated by the MIB.

Some examples of the method, network entities, and non-transitory computer-readable medium described herein may further include operations, features, means, or instructions for outputting the SIB may be in accordance with an FDRA associated with the SIB and the FDRA may be in accordance with a rule indicative of FDRAs for SIBs of which coding rates may be indicated by MIBs.

Some examples of the method, network entities, and non-transitory computer-readable medium described herein may further include operations, features, means, or instructions for outputting, via the MIB, information indicative of an FDRA associated with the SIB, where the SIB may be output in accordance with the FDRA indicated by the MIB.

In some examples of the method, network entities, and non-transitory computer-readable medium described herein, the network entity outputs the SIB via the PDSCH without outputting a control message via a PDCCH that schedules the SIB.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports communication of system information via a physical downlink shared channel (PDSCH) in accordance with information provided by a master information block (MIB) in accordance with one or more aspects of the present disclosure.

FIGS. 2 and 3 show examples of multiplexing patterns that support communication of system information via a PDSCH in accordance with information provided by a MIB in accordance with one or more aspects of the present disclosure.

FIG. 4 shows an example of a signaling diagram that supports communication of system information via a PDSCH in accordance with information provided by a MIB in accordance with one or more aspects of the present disclosure.

FIGS. 5-7 show examples of time domain resource assignment (TDRA) schemes that support communication of system information via a PDSCH in accordance with information provided by a MIB in accordance with one or more aspects of the present disclosure.

FIG. 8 shows an example of a circular buffer that supports communication of system information via a PDSCH in accordance with information provided by a MIB in accordance with one or more aspects of the present disclosure.

FIG. 9 shows an example of a process flow that supports communication of system information via a PDSCH in accordance with information provided by a MIB in accordance with one or more aspects of the present disclosure.

FIGS. 10 and 11 show block diagrams of devices that support communication of system information via a PDSCH in accordance with information provided by a MIB in accordance with one or more aspects of the present disclosure.

FIG. 12 shows a block diagram of a communications manager that supports communication of system information via a PDSCH in accordance with information provided by a MIB in accordance with one or more aspects of the present disclosure.

FIG. 13 shows a diagram of a system including a device that supports communication of system information via a PDSCH in accordance with information provided by a MIB in accordance with one or more aspects of the present disclosure.

FIGS. 14 and 15 show block diagrams of devices that support communication of system information via a PDSCH in accordance with information provided by a MIB in accordance with one or more aspects of the present disclosure.

FIG. 16 shows a block diagram of a communications manager that supports communication of system information via a PDSCH in accordance with information provided by a MIB in accordance with one or more aspects of the present disclosure.

FIG. 17 shows a diagram of a system including a device that supports communication of system information via a PDSCH in accordance with information provided by a MIB in accordance with one or more aspects of the present disclosure.

FIGS. 18-21 show flowcharts illustrating methods that support communication of system information via a PDSCH in accordance with information provided by a MIB in accordance with one or more aspects of the present disclosure.

### DETAILED DESCRIPTION

In some wireless communication networks, a network entity may periodically transmit (e.g., broadcast) information that a user equipment (UE) may use to establish a connection with (and to communicate with) the network entity. The network entity may transmit such information via multiple information blocks including, for example, a master information block (MIB) and one or more system information blocks (SIBs). The network entity may transmit the MIB via a physical broadcast channel (PBCH) as part of a synchronization signal block (SSB) and may provide via, the MIB, one or more communication parameters associated with the network entity. In some cases, such communication parameters may indicate information associated with a physical downlink control channel (PDCCH) via which the network entity may schedule a first system information block (SIB1). For example, a UE may monitor a PDCCH in accordance with the information provided by the MIB for a control message (e.g., a downlink control information (DCI) message) that schedules SIB1. The network entity may transmit the SIB1 via a physical downlink shared channel (PDSCH) in accordance with the scheduling information indicated by the control message. The SIB1 may be understood or referred to herein as remaining minimum system information (RMSI) and, likewise, the PDSCH via which the network entity transmits SIB1 may be understood or referred to herein as an RMSI PDSCH. Similarly, the PDCCH that schedules the SIB1 may be understood or referred to herein as an RMSI PDCCH.

The PDCCH that schedules the RMSI PDSCH may be a coverage bottleneck in some operating frequency ranges (FRs), such as FR2, due to a course beam direction stemming from (e.g., associated with, based on, or resulting from) a broadcast nature of the PDCCH. Additionally, or alternatively, the RMSI PDSCH via which the network entity transmits the SIB1 may become a coverage bottleneck in some cases, such as cases in which the SIB1 (e.g., the RMSI) payload is relatively large. Such a coverage bottleneck of the RMSI PDSCH may become more impactful or severe for some SSB multiplexing patterns, such as SSB multiplexing patterns in which the RMSI PDSCH is frequency division multiplexed with the SSB. Lower RMSI PDSCH coverage may result in or otherwise be associated with a greater likelihood of at least some UEs failing to successfully receive and decode the SIB1, which may delay such UEs connection establishment with the network entity or result in greater power consumption at such UEs (by way of such UEs attempting to receive and decode the SIB1 multiple times). Thus, some networks may benefit from greater RMSI PDSCH coverage.

Various aspects generally relate to increasing RMSI PDSCH coverage by using (such as re-purposing) one or more PDCCH resource elements (REs) for the RMSI PDSCH and, in some implementations, removing an expectation of a UE to decode an RMSI PDCCH. For example, in some implementations, a network entity and one or more UEs may support a relatively larger RMSI PDSCH via which to communicate SIB1 by re-purposing PDCCH REs as RMSI PDSCH REs (e.g., by using one or more PDCCH resources as supplemental or additional RMSI PDSCH resources). Some aspects more specifically relate to one or more signaling- or configuration-based mechanisms according to which a UE may receive, select, determine, calculate, ascertain, or otherwise acquire information pertaining to one or more parameters or resources of SIB1 via a MIB or in accordance with one or more rules (e.g., one or more fixed, default, or signaled rules or assumptions) associated with RMSI PDSCH reception. In other words, the UE may receive, select, determine, calculate, ascertain, or otherwise acquire information pertaining to such parameters or resources without receiving a control message that schedules the RMSI PDSCH. Such parameters or resources of the SIB1 (e.g., the RMSI PDSCH) may include one or more of a coding rate, a time domain resource assignment (TDRA), a frequency domain resource assignment (FDRA), a virtual resource block (VRB)-to-physical resource block (PRB) mapping, or a redundancy version (RV), among other examples.

In some examples, a network entity may transmit at least an indication of the coding rate of the SIB1 (e.g., the coding rate of the RMSI PDSCH) via a MIB. The network entity may additionally convey information pertaining to one or more other parameters or resources of the SIB1 via the MIB. Additionally, or alternatively, the network entity or a UE may use one or more rules to determine one or more other parameters or resources of the SIB1. For example, the network entity and various UEs may activate one or more rules associated with determining one or more parameters or resources of the SIB1 in accordance with the MIB indicating the coding rate of the SIB1. In other words, such one or more rules associated with determining one or more parameters or resources of the SIB1 may be activated in or applicable to scenarios in which a MIB indicates a coding rate of a SIB1 (which may, implicitly or explicitly, indicate an absence of an RMSI PDCCH message scheduling the SIB1).

Particular aspects of the subject matter described in this disclosure can be implemented to realize one or more of the following potential advantages. In some examples, by increasing the amount of REs associated with an RMSI PDSCH, a network entity may facilitate greater RMSI PDSCH coverage such that relatively more UEs may have a relatively greater likelihood of successfully receiving and decoding SIB1 (including SIB1s with relatively large payload sizes). In accordance with such a relatively greater likelihood of successfully receiving and decoding SIB1, one or more UEs may experience faster (lower latency) connection times and less power consumption. Further, by indicating at least a coding rate of a SIB1 via a MIB, network entities and UEs may efficiently support various coding rates across SIB1s (such that a first SIB1 may have a first coding rate and a second SIB1 may have a second coding rate), which may enable devices within the network to adapt or configure to various channel conditions, operating scenarios, or transport block sizes (TBSs) for SIB1.

Additionally, by indicating information pertaining to one or more other parameters or resources of the SIB1 via the MIB, network entities and UEs may efficiently support further variation across SIB1s with relatively greater network flexibility. By determining information pertaining to one or more other parameters or resources of the SIB1 in accordance with one or more (fixed, default, or signaled) rules, network entities and UEs may maintain relatively lower signaling overhead while still ensuring synchronization and compatibility (e.g., mutual understandings) regarding the parameters/resources of SIB1. In accordance with such flexibility or synchronization, or both, the described techniques may be further implemented to realize greater spectral efficiency, higher data rates, greater processing efficiency, greater system capacity, and higher throughput, among other benefits. Furthermore, by removing the need or expectation to decode an RMSI PDCCH to be able to receive or decode the RMSI PDSCH (SIB1), issues resulting from PDCCH decoding error can be avoided, and in addition, a UE may save power by not attempting to perform blind decoding for RMSI PDCCH.

Aspects of the disclosure are initially described in the context of wireless communications systems. Additionally, aspects of the disclosure are illustrated by and described with reference to multiplexing patterns, a signaling diagram, TDRAs, a circular buffer, and a process flow. Aspects of the disclosure are further illustrated by and described with reference to apparatus diagrams, system diagrams, and flowcharts that relate to communication of system information via a physical downlink shared channel in accordance with information provided by a master information block.

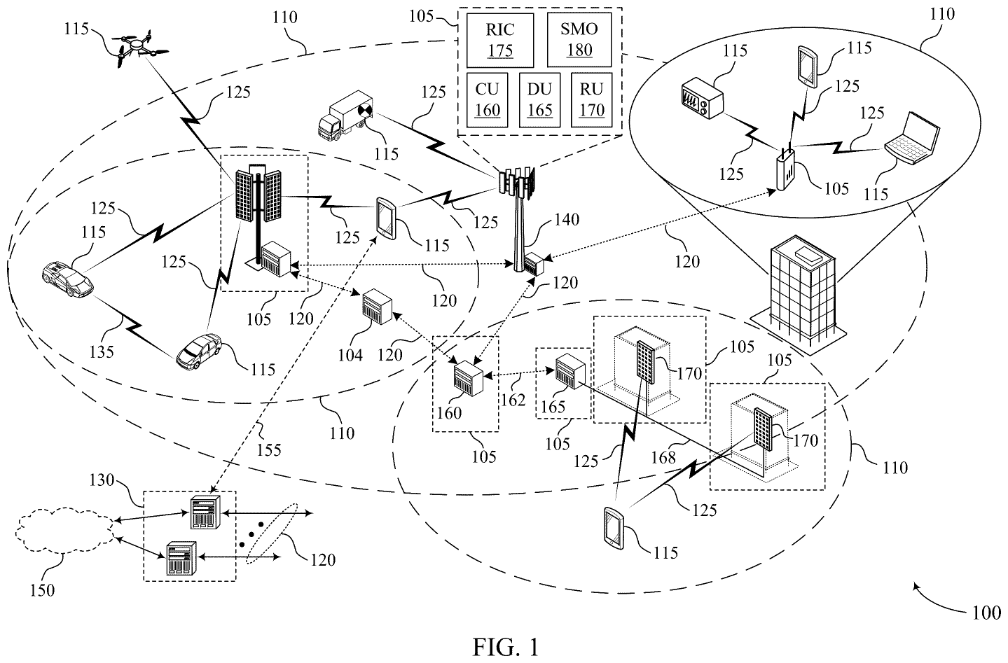

FIG. 1 shows an example of a wireless communications system 100 that supports communication of system information via a physical downlink shared channel in accordance with information provided by a master information block in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nr) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, such as the wireless communications system 100 (which may be an example of a 5G NR system), a network entity 105 and a UE 115 may support various search space (SS) types. Such SS types may be associated with same or different downlink control information (DCI) formats. A first SS type may be a Type0-PDCCH common search space (CSS) set configured by pdcch-ConfigSIB1 in MIB, by searchSpaceSIB1 in PDCCH-ConfigCommon, or by searchSpaceZero in PDCCH-ConfigCommon for a DCI format with cyclic redundancy check (CRC) scrambled by a system information-radio network temporary identifier (SI-RNTI) on a primary cell of a master cell group (MCG). Such a DCI format for the Type0-PDCCH CSS set may be a DCI format 1_0. A second SS type may be a Type0A-PDCCH CSS set configured by searchSpaceOtherSystemInformation in PDCCH-ConfigCommon for a DCI format with CRC scrambled by an SI-RNTI on a primary cell of an MCG. Such a DCI format for the Type0A-PDCCH CSS set may be a DCI format 1_0.

A third SS type may be a Type1-PDCCH CSS set configured by ra-SearchSpace in PDCCH-ConfigCommon for a DCI format with CRC scrambled by a random access-RNTI (RA-RNTI), a message B-RNTI (msgB-RNTI), or temporary cell-RNTI (TC-RNTI) on a primary cell. Such a DCI format for the Type1-PDCCH CSS set may be a DCI format 1_0 or a DCI format 0_0. A fourth SS type may be a Type2-PDCCH CSS set configured by pagingSearchSpace in PDCCH-ConfigCommon for a DCI format with CRC scrambled by a paging-RNTI (P-RNTI) on a primary cell of an MCG. Such a DCI format for the Type2-PDCCH CSS set may be a DCI format 1_0.

A network entity 105 and a UE 115 may support one or more of various SSB and control resource set (CORESET) (e.g., CORESET0) multiplexing patterns. Additionally, a network entity 105 may deliver (e.g., transmit) various types of system information. For example, a network entity 105 may transmit a first portion of system information via a MIB as part of an SSB. The network entity 105 may transmit the MIB via a PBCH (as part of the SSB) in accordance with a periodic broadcast. The network entity 105 may transmit a second portion of system information via SIB1 (which may be understood or referred to as RMSI) via a PDSCH scheduled by a PDCCH associated with a Type0-CSS. For example, a DCI format 1_0 with SI-RNTI monitored on a Type0-CSS may schedule the RMSI PDSCH. The network entity 105 may transmit the SIB1 in accordance with a periodic broadcast. Additionally, in some examples, the network entity 105 may transmit a third portion of system information via one or more other SIBs, such as SIB2-SIB9 (which may be understood or referred to as other system information (OSI)). The network entity 105 may transmit SIB2-SIB9 via a PDSCH scheduled by a PDCCH associated with a Type0A-CSS. The network entity 105 may transmit SIB2-SIB9 in accordance with an on-demand delivery in accordance with (e.g., based on or responsive to) a request by a UE 115.

In some systems, a MIB may include one or more communication parameters. Such communication parameters may include or be indicated by, for example, a systemFrameNumber field or parameter, a subCarrierSpacingCommon field or parameter, an ssb-SubcarrierOffset field or parameter, a dmrs-TypeA-Position field or parameter, a pdcch-ConfigSIB1 field or parameter, a cellbarred field or parameter, an intraFreqReselection field or parameter, one or more “spare” bits (e.g., single spare bit associated with a bit string size of 1), or any combination thereof. The PDCCH-ConfigSIB1 field or parameter (or, equivalently, the pdcch-ConfigSIB1 field or parameter) may include one or both of a controlResourceSetZero information element (IE) or a searchSpaceZero IE. The controlResourceSetZero IE may include or indicate an integer value (e.g., an index value) between 0-15 and the searchSpaceZero IE may include or indicate an integer value (e.g., an index value) between 0-15. The controlResourceSetZero IE may indicate a CORESET0 configuration and the searchSpaceZero IE may indicate a search space set (SSS) 0 (SSS0) configuration.

A UE 115 may monitor Type0-CSS on a specific CORESET or SSS, such as CORESET0 or SSS0. The Type0-CSS may be configured via the MIB (e.g., via the pdcch-ConfigSIB1 field or parameter). A CORESET0 configuration may be associated with (e.g., indicated by) an index between 0-15 (based on one or more specified tables). In some cases, an index may determine (e.g., point to or indicate) the CORESET0 bandwidth (e.g., a quantity of resource blocks (RBs) or RB locations relative to SSB, which may determine an initial downlink BWP, i.e., BWP #0) and a quantity of symbols for the CORESET. For some CORESET0/SSB multiplexing patterns, such as CORESET0/SSB multiplexing patterns 2 and 3, some of the indices associated with CORESET0 configurations may be unused or reserved.

A SSS0 configuration may be associated with (e.g., indicated by) an index between 0-15 (based on one or more specified tables). In some cases, an index may determine (e.g., point to or indicate) the monitoring occasions of SSS0 including an SFN, a slot, or a starting symbol, among other examples. For some CORESET0/SSB multiplexing patterns, such as CORESET0/SSB multiplexing patterns 2 and 3, the index that corresponds to the SSS0 configuration may be fixed. In other words, searchSpaceZero in pdcch-ConfigSIB1 in the MIB may be unused or reserved (such that there is one possibility for monitoring occasions of SSS0 for such CORESET0/SSB multiplexing patterns).

A network entity 105 may periodically broadcast RMSI (e.g., SIB1) according to a CORESET0/SSB multiplexing pattern. In some systems, a network entity 105 and various UEs 115 may support various CORESET0/SSB multiplexing patterns including, for example, a CORESET0/SSB multiplexing pattern 1, a CORESET0/SSB multiplexing pattern 2, and a CORESET0/SSB multiplexing pattern 3. In accordance with the CORESET0/SSB multiplexing pattern 1, RMSI PDCCH/PDSCH may be time division multiplexed with an SSB in FR1/FR2. For example, in accordance with the CORESET0/SSB multiplexing pattern 1, an SSB may occupy a first set of one or more symbols, an RMSI PDCCH may occupy a second set of one or more symbols, and an RMSI PDSCH may occupy a third set of one or more symbols (with the first, second, and third sets of symbols being non-overlapping with each other).

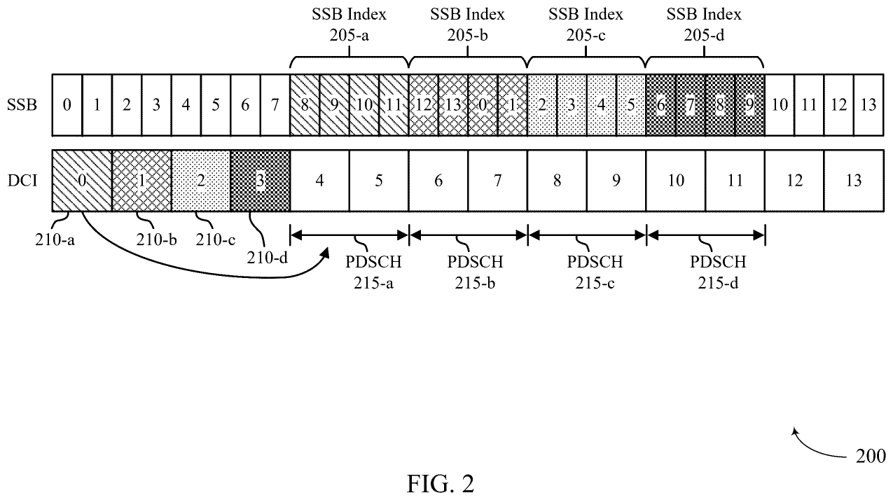

In accordance with the CORESET0/SSB multiplexing pattern 2, RMSI PDCCH/PDSCH may be time division multiplexed and frequency division multiplexed with an SSB in FR2. A quantity of symbols allocated for the RMSI PDCCH and the RMSI PDSCH may depend on a subcarrier spacing (SCS) associated with the SSB and the RMSI PDCCH/PDSCH. For some SCSs, there may be a 1-symbol RMSI PDCCH and a 2-symbol RMSI PDSCH. For example, for (SSB SCS, RMSI PDCCH/PDSCH SCS)=(120, 60) kHz, there may be a 1-symbol RMSI PDCCH and a 2-symbol RMSI PDSCH. For further example, for (SSB SCS, RMSI PDCCH/PDSCH SCS)=(240, 120) kHz, there may be a 1-symbol RMSI PDCCH and a 2-symbol RMSI PDSCH. Additional details associated with the CORESET0/SSB multiplexing pattern 2 are illustrated by and described with reference to FIG. 2.

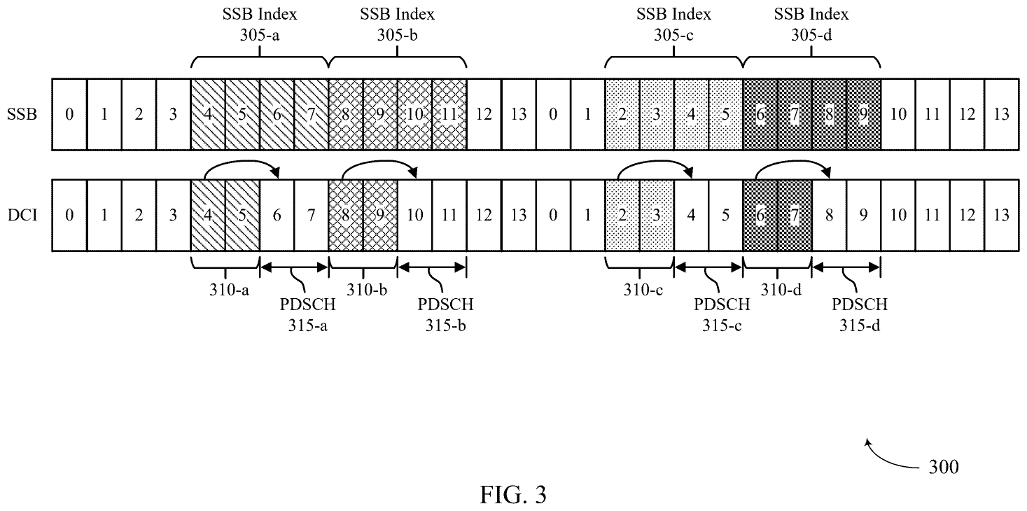

In accordance with the CORESET0/SSB multiplexing pattern 3, the RMSI PDCCH/PDSCH may be frequency division multiplexed with an SSB in FR2. A quantity of symbols allocated for the RMSI PDCCH and the RMSI PDSCH may depend on an SCS associated with the SSB and the RMSI PDCCH/PDSCH. For some SCSs, there may be a 2-symbol RMSI PDCCH and a 2-symbol RMSI PDSCH. For example, for (SSB SCS, RMSI PDCCH/PDSCH SCS)=(120, 120) kHz, there may be a 2-symbol RMSI PDCCH and a 2-symbol RMSI PDSCH. Additional details associated with the CORESET0/SSB multiplexing pattern 3 are illustrated by and described with reference to FIG. 3.

In some implementations, a network entity 105 and one or more UEs 115 may extend (e.g., increase, strengthen, or enhance) RMSI PDSCH coverage by using (such as re-purposing) one or more PDCCH REs (such as one or more REs from CORESET0) for the RMSI PDSCH. In some examples, the network entity 105 and the one or more UEs 115 may support a protocol associated with an absence of an expectation of a UE 115 to decode an RMSI PDCCH to receive an RMSI PDSCH. For example, the network entity 105 and the one or more UEs 115 may support a relatively larger RMSI PDSCH via which to receive SIB1 by re-purposing PDCCH REs as RMSI PDSCH REs (e.g., by using at least a portion of PDCCH resources as supplemental or additional RMSI PDSCH resources). In such examples, the UE 115 may refrain from monitoring CORESET0 (for RMSI PDCCH scheduling RMSI PDSCH, e.g., SIB1) and may instead monitor for, receive, or decode SIB1 via an RMSI PDSCH in accordance with receiving the MIB (e.g., based directly on receiving the MIB without an RMSI PDCCH message).

In some implementations, the network entity 105 may use or generate the MIB in accordance with a MIB format that is associated with an absence of CORESET0 monitoring by a UE 115 for RMSI PDCCH. Such a MIB format may be associated with one or more different parameters or fields as compared to MIB formats associated with a presence of CORESET0 monitoring for RMSI PDCCH or may be associated with one or more different parameter or field interpretations as compared to MIB formats associated with a presence of CORESET0 monitoring for RMSI PDCCH, or any combination thereof. For example, a MIB format that is associated with an absence of CORESET0 monitoring for RMSI PDCCH may exclude a pdcch-ConfigSIB1 field or parameter or may be associated with a different interpretation/use of the pdcch-ConfigSIB1 field or parameter. In examples in which an absence or lack of CORESET0 monitoring for RMSI PDCCH is expected by the network entity 105 and one or more UEs 115, the MIB format may include one or more parameters or fields that convey information pertaining to SIB1 (e.g., an RMSI PDSCH) reception by one or more UEs 115. In some aspects, a UE 115 may refrain from monitoring CORESET0 or SSS0 for RMSI PDCCH signaling, but may monitor CORESET0 or SSS0 for other downlink control signaling (e.g., for paging DCIs or DCIs scrambled by RA-RNTI, among other examples)

For example, some aspects further relate to one or more signaling- or configuration-based mechanisms according to which a UE 115 may receive, select, determine, calculate, ascertain, or otherwise acquire information pertaining to one or more parameters or resources of SIB1 via a MIB or in accordance with a rule (e.g., a fixed, default, or signaled rule or assumption) associated with RMSI PDSCH reception. In other words, the UE 115 may receive, select, determine, calculate, ascertain, or otherwise acquire information pertaining to such parameters or resources without receiving a control message that schedules the RMSI PDSCH. Such parameters or resources of the SIB1 may include one or more of a coding rate, a TBS, a TDRA, an FDRA, a VRB-to-PRB mapping, or an RV, among other examples.

In some examples, a network entity 105 may transmit at least an indication of the coding rate of the SIB1 (e.g., the coding rate of the RMSI PDSCH) via a MIB. Additionally, or alternatively, the network entity 105 may transmit at least an indication of the TBS of the SIB1 (e.g., the TBS of the RMSI PDSCH) via a MIB. In some aspects, a TBS may be derived from a coding rate and a coding rate may be derived from a TBS (for a given set of resources). A coding rate may be equivalently referred to as a code rate. The network entity 105 may additionally convey information pertaining to one or more other parameters or resources of the SIB1 via the MIB or may activate one or more rules associated with determination of one or more other parameters or resources of the SIB1 by indicating the coding rate or the TBS of the SIB1 via the MIB. For example, the network entity 105 and various UEs 115 may support one or more rules associated with determining one or more parameters or resources of the SIB1 in accordance with (such as based on or as a result of) the MIB indicating the coding rate or the TBS of the SIB1. In other words, such one or more rules associated with determining one or more parameters or resources of the SIB1 may be activated in or applicable to scenarios in which a MIB indicates a coding rate or a TBS of a SIB1 (which may, at least implicitly, indicate an absence of a RMSI PDCCH message scheduling the SIB1/RMSI PDSCH).

FIG. 2 shows an example of a multiplexing pattern 200 that supports communication of system information via a PDSCH in accordance with information provided by a MIB in accordance with one or more aspects of the present disclosure. The multiplexing pattern 200 may illustrate an example of a CORESET0/SSB multiplexing pattern 2, which may be associated with both TDM and FDM between a CORESET0, a PDSCH (e.g., an RMSI PDSCH), and an SSB. For example, the CORESET0 may be time division multiplexed with the PDSCH and the SSB and the PDSCH may be frequency division multiplexed with the SSB.

In some cases, such as cases in which one or more UEs 115 monitor CORESET0 for a DCI message scheduling SIB1 via an RMSI PDSCH, a network entity 105 may transmit DCI associated with each SSB index to schedule a PDSCH (e.g., an RMSI PDSCH carrying SIB1) for each SSB index. In other words, each SSB index may be associated with a respective DCI and a respective RMSI PDSCH. As illustrated in the example of the multiplexing pattern 200, the network entity 105 may transmit SSBs associated with an SSB index 205-a, an SSB index 205-b, an SSB index 205-c, and an SSB index 205-d. Each SSB index may be associated with an SSB/PBCH transmission, including a MIB. In the example of the multiplexing pattern 200, each SSB/PBCH transmission may be associated with (e.g., span) four symbols.

The network entity 105 may transmit a DCI 210-a scheduling a PDSCH 215-a associated with the SSB index 205-a, a DCI 210-b scheduling a PDSCH 215-b associated with the SSB index 205-b, a DCI 210-c scheduling a PDSCH 215-c associated with the SSB index 205-c, and a DCI 210-d scheduling a PDSCH 215-d associated with the SSB index 205-d. The PDSCH 215-a may carry a first SIB1 associated with the SSB index 205-a, the PDSCH 215-b may carry a second SIB1 associated with the SSB index 205-b, the PDSCH 215-c may carry a third SIB1 associated with the SSB index 205-c, and the PDSCH 215-d may carry a fourth SIB1 associated with the SSB index 205-d.

In some examples, each of the DCIs may be associated with (e.g., span) one symbol and each of the scheduled PDSCHs (which may be examples of RMSI PDSCHs carrying SIB1) may be associated with (e.g., span) two symbols. Further, although four SSB indices are illustrated in the example of the multiplexing pattern 200, a network entity 105 may perform any quantity of SSB/PBCH transmissions associated with any quantity of SSB indices, such as four SSB indices, five SSB indices, six SSB indices, seven SSB indices, or eight SSB indices, among other examples. Each SSB index may be associated with a respective periodicity in accordance with the periodic broadcasting at the network entity 105.

In accordance with some example implementations, the network entity 105 and one or more UEs 115 may support a protocol according to which one or more of the PDSCH 215-a, the PDSCH 215-b, the PDSCH 215-c, and the PDSCH 215-d are extended or enlarged for greater coverage. For example, the network entity 105 and one or more UEs 115 may use, or expect that one or more CORESET0 REs are used, as PDSCH REs to provide a greater quantity of resources for the RMSI PDSCH carrying SIB1. In some of such examples, the network entity 105 and the one or more UEs 115 may refrain from transmitting and refrain from receiving, respectively, DCI via the CORESET0. In accordance with refraining from communicating DCI scheduling an RMSI PDSCH, the network entity 105 and the one or more UEs 115 may support one or more signaling- or configuration-based mechanisms according to which a UE 115 may receive, select, determine, calculate, ascertain, or otherwise acquire information pertaining to one or more parameters or resources of SIB1 (e.g., an RMSI PDSCH) via a MIB or in accordance with a rule.

FIG. 3 shows an example of a multiplexing pattern 300 that supports communication of system information via a PDSCH in accordance with information provided by a MIB in accordance with one or more aspects of the present disclosure. The multiplexing pattern 300 may illustrate an example of a CORESET0/SSB multiplexing pattern 3, which may be associated with FDM of a CORESET0 and a PDSCH (e.g., an RMSI PDSCH) with an SSB. For example, the CORESET0 may be time division multiplexed with the PDSCH and the SSB, and both the CORESET0 and the PDSCH may be frequency division multiplexed with the SSB.

In some cases, such as cases in which one or more UEs 115 monitor CORESET0 for a DCI message scheduling SIB1 via an RMSI PDSCH, a network entity 105 may transmit DCI associated with each SSB index to schedule a PDSCH (e.g., an RMSI PDSCH carrying SIB1) for each SSB index. In other words, each SSB index may be associated with a respective DCI and a respective RMSI PDSCH. As illustrated in the example of the multiplexing pattern 300, the network entity 105 may transmit SSBs associated with an SSB index 305-a, an SSB index 305-b, an SSB index 305-c, and an SSB index 305-d. Each SSB index may be associated with an SSB/PBCH transmission, including a MIB. In the example of the multiplexing pattern 300, each SSB/PBCH transmission may be associated with (e.g., span) four symbols.

The network entity 105 may transmit a DCI 310-a scheduling a PDSCH 315-a associated with the SSB index 305-a, a DCI 310-b scheduling a PDSCH 315-b associated with the SSB index 305-b, a DCI 310-c scheduling a PDSCH 315-c associated with the SSB index 305-c, and a DCI 310-d scheduling a PDSCH 315-d associated with the SSB index 305-d. The PDSCH 315-a may carry a first SIB1 associated with the SSB index 305-a, the PDSCH 315-b may carry a second SIB1 associated with the SSB index 305-b, the PDSCH 315-c may carry a third SIB1 associated with the SSB index 305-c, and the PDSCH 315-d may carry a fourth SIB1 associated with the SSB index 305-d.

In some examples, each of the DCIs may be associated with (e.g., span) two symbols and each of the scheduled PDSCHs (which may be examples of RMSI PDSCHs carrying SIB1) may be associated with (e.g., span) two symbols. Further, although four SSB indices are illustrated in the example of the multiplexing pattern 300, a network entity 105 may perform any quantity of SSB/PBCH transmissions associated with any quantity of SSB indices, such as four SSB indices, five SSB indices, six SSB indices, seven SSB indices, or eight SSB indices, among other examples. Each SSB index may be associated with a respective periodicity in accordance with the periodic broadcasting at the network entity 105.

In accordance with some example implementations, the network entity 105 and one or more UEs 115 may support a protocol according to which one or more of the PDSCH 315-a, the PDSCH 315-b, the PDSCH 315-c, and the PDSCH 315-d are extended or enlarged for greater coverage. For example, the network entity 105 and one or more UEs 115 may use, or expect that one or more CORESET0 REs are used, as PDSCH REs to provide a greater quantity of resources for the RMSI PDSCH carrying SIB1. In some of such examples, the network entity 105 and the one or more UEs 115 may refrain from transmitting and refrain from receiving, respectively, DCI via the CORESET0. In accordance with refraining from communicating DCI scheduling an RMSI PDSCH, the network entity 105 and the one or more UEs 115 may support one or more signaling- or configuration-based mechanisms according to which a UE 115 may receive, select, determine, calculate, ascertain, or otherwise acquire information pertaining to one or more parameters or resources of SIB1 (e.g., an RMSI PDSCH) via a MIB or in accordance with a rule.

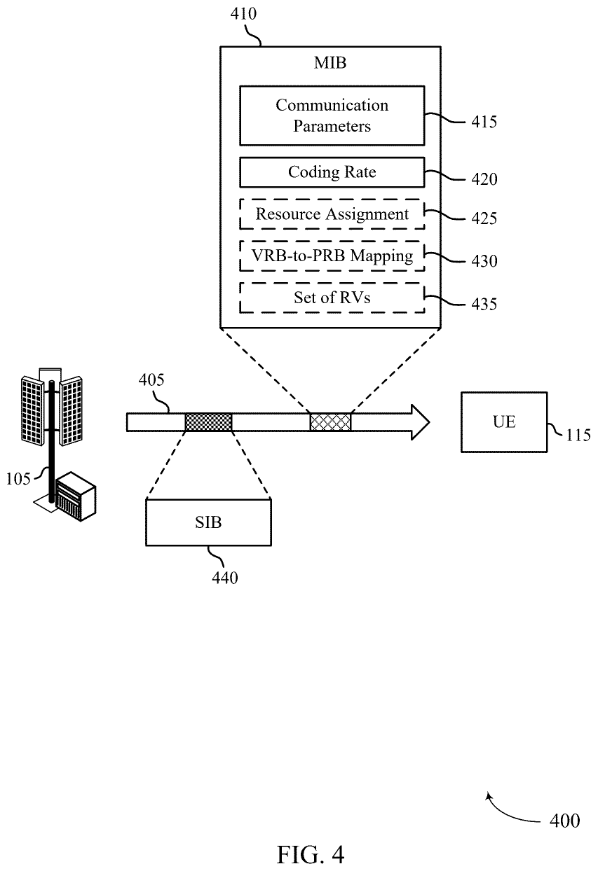

FIG. 4 shows an example of a signaling diagram 400 that supports communication of system information via a PDSCH in accordance with information provided by a MIB in accordance with one or more aspects of the present disclosure. The signaling diagram 400 illustrates communication between a network entity 105 and a UE 115, which may be examples of corresponding devices illustrated and described herein. The network entity 105 and the UE 115 may communicate via a communication link 405, which may be an example of a communication link 125 as illustrated by and described with reference to FIG. 1.

The network entity 105 may transmit (e.g., broadcast, such as via a PBCH) a MIB 410 indicting one or more communication parameters 415 associated with the network entity 105. In some cases, the UE 115 may expect to monitor a PDCCH (e.g., a CORESET, such as CORESET0) for DCI scheduling an RMSI PDSCH via which to receive a SIB 440 (e.g., a SIB1). In such cases (among others), the one or more communication parameters 415 may include or indicate an SFN (via a systemFrameNumber field or parameter), an SCS (via a subCarrierSpacingCommon field or parameter), an SSB subcarrier offset (via an ssb-SubcarrierOffset field or parameter), a demodulation reference signal (DMRS) position (via a dmrs-TypeA-Position field or parameter), a PDCCH configuration (via a pdcch-ConfigSIB1 field or field or parameter), a cell barred indication (via a cellbarred field or parameter), and an intra-frequency reselection indication (via an intraFreqReselection field or parameter). In such cases, the UE 115 may monitor a PDCCH configured in accordance with pdcch-ConfigSIB1 to receive a DCI message scheduling the SIB 440.

In some scenarios (such as scenarios involving FR2 communication), however, the PDCCH that schedules the RMSI (e.g., the SIB 440) may be a coverage bottleneck due to a course beam direction of the PDCCH in accordance with a broadcast nature of the PDCCH scheduling the RMSI (as the network entity 105 may transmit DCI scheduling the RMSI via the PDCCH prior to performing a beam refinement procedure with a UE 115). Additionally, or alternatively, the RMSI PDSCH (carrying the SIB 440) may become the coverage bottleneck in some scenarios, such as scenarios in which an RMSI payload is large in FR2. The coverage of the RMSI PDSCH may be further limited in some CORESET0/SSB multiplexing patterns, such as in CORESET0/SSB multiplexing patterns 2 and 3.

For example, for CORESET0/SSB multiplexing patterns 2 and 3, the RMSI PDSCH may be contained within (e.g., limited to) the SSB symbols. Further, the CORESET0 REs may be spent on sending the RMSI PDCCH, leaving fewer resources for the RMSI PDSCH (e.g., for CORESET0/SSB multiplexing pattern 3 in particular). Additionally, because the RMSI PDSCH is currently frequency division multiplexed with the SSB on the same symbols and because an upper limit of a 2-symbol PDSCH can be allocated for the RMSI (e.g., the SIB 440), the coding rate of the RMSI may become high (e.g., higher than a threshold or, generally, high enough such that reception and decoding may be compromised in some channel conditions). If both PDCCH and PDSCH symbols can be used for the SIB 440, however, the network entity 105 may provide greater coverage gain for the SIB 440 (such as more than 3 decibel (dB) coverage gain).

Thus, some networks may benefit from increased (e.g., enhanced) RMSI PDSCH coverage by using PDCCH REs and, in at least some scenarios, removing an expectation to decode RMSI PDCCH at the UE 115. Accordingly, in some implementations of the present disclosure, the UE 115 may directly attempt to decode RMSI PDSCH (e.g., the SIB 440), with the parameters or resources associated with the RMSI PDSCH indicated via the MIB 410 or determined based on a (fixed, default, or signaled) rule or assumption. In implementations in which one or more parameters or resources associated with the RMSI PDSCH are based on a rule or assumption, the MIB 410 may refrain from carrying information indicative of such parameters or resources. For example, with (CORESET0/SSB) multiplexing patterns 2 and 3, TDRA signaling may be avoided in some implementations (as the TDRA of the RMSI PDSCH may be based on or aligned with the SSB location). For further example, FDRA signaling also may be avoided in some implementations (as the FDRA of the RMSI PDSCH may be assumed to be all CORESET0 RBs (e.g., 24 or 48 RBs) in some scenarios, such as high coding rate scenarios).

Alternatively, in some other implementations or scenarios, one or both of the TDRA or the FDRA (or at least a portion of the TDRA or the FDRA) of the RMSI PDSCH (e.g., the SIB 440) may be signaled via the MIB 410. Generally, in implementations in which some information pertaining to reception of the SIB 440 is conveyed via the MIB 410, a set of bits (e.g., 3, 4, or 5 bits) of the pdcch-ConfigSIB1 field in the MIB 410 may be used to indicate one or more parameters or resources associated with the RMSI PDSCH without increasing a payload size of the MIB 410 (as compared to, for example, a MIB format associated with 5G NR systems). For example, for (CORESET0/SSB) multiplexing patterns 2 and 3, at least a subset of the bits of the pdcch-ConfigSIB1 field (which may include one bit of the controlResourceSetZero IE and four bits of the searchSpaceZero IE) may be unused or reserved, with such bits available to indicate one or more parameters or resources associated with the RMSI PDSCH.

In some implementations, the network entity 105 and the UE 115 may activate, use, or employ a protocol according to which parameter(s)/resource(s) associated with RMSI PDSCH occasions are determined based on information included in the MIB 410 (without RMSI PDCCH in Type0-CSS) in accordance with some select or specific multiplexing patterns (e.g., some select or specific CORESET0/SSB multiplexing patterns). For example, such functionality at the network entity 105 and the UE 115 may be used for CORESET0/SSB multiplexing patterns 2 and 3 in which there may be a single RMSI PDSCH occasion in each SSB periodicity (e.g., every 20 milliseconds) without an associated PDCCH. For further example, such functionality at the network entity 105 and the UE 115 may not be used for CORESET0/SSB multiplexing pattern 1.

In accordance with an absence of an RMSI PDCCH, the MIB 410 may include an indication of a coding rate 420. Additionally, or alternatively, the MIB 410 may include an indication of a TBS. For a given set of resources for RMSI PDSCH and for a given modulation order (e.g., quadrature phase shift keying (QPSK)), coding rate may be derived from TBS and vice versa. In other words, in some implementations, the MIB 410 may include at least an indication of the coding rate 420, along with the one or more communication parameters 415. In examples in which there is an absence of (an expectation to receive) an RMSI PDCCH scheduling the SIB 440, the one or more communication parameters 415 may include or indicate an SFN (via a systemFrameNumber field or parameter), an SCS (via a subCarrierSpacingCommon field or parameter), an SSB subcarrier offset (via an ssb-SubcarrierOffset field or parameter), a DMRS position (via a dmrs-TypeA-Position field or parameter), a cell barred indication (via a cellbarred field or parameter), an intra-frequency reselection indication (via an intraFreqReselection field or parameter), or any combination thereof.

In some implementations, the MIB 410 may indicate the coding rate 420 via one or more fields, parameters, IEs, or bits. For example, the network entity 105 may indicate the coding rate 420 via a set of bits (e.g., 3 or 4 bits) of the MIB 410. In some examples, a modulation order associated with the SIB 440 may be assumed to be fixed, such as fixed to a QPSK modulation order or scheme. In such examples, the set of bits may be included within a field (e.g., a dedicated field) of the MIB 410 or may be based on the searchSpaceZero IE in the pdcch-ConfigSIB1 field of the MIB 410 (which may be unused or fixed (in NR) for CORESET0/SSB multiplexing patterns 2 and 3).

In implementations in which the MIB 410 includes the indication of the coding rate 420, the UE 115 may determine (e.g., calculate) a transport block size (TBS) associated with the RMSI PDSCH carrying the SIB 440 in accordance with the coding rate 420 indicated by the MIB 410 (and, in some examples, in accordance with the TDRA and the FDRA associated with the SIB 440). The TBS associated with the RMSI PDSCH carrying the SIB 440 may vary between different infrastructure networks or operators. The UE 115 may acquire (e.g., receive, determine, or derive) information indicative of other parameters/resources associated with the SIB 440 via indications in the MIB 410, in accordance with one or more default/fixed rules or assumptions, or any combination thereof (in accordance with, for example, a tradeoff between system flexibility and MIB overhead). Such other parameters/resources associated with the SIB 440 may include a resource assignment 425 (e.g., one or both of a TDRA and an FDRA), a VRB-to-PRB mapping 430 (e.g., a VRB-PRB mapping), a set of RVs 435 (e.g., a set of available RVs), or any combination thereof, among other examples.

In some implementations, the network entity 105 and the UE 115 may determine a TDRA associated with the SIB 440 in accordance with one or more fixed, default, or signaled rules or assumptions. In some examples, the network entity 105 and the UE 115 may determine that the SIB 440 occupies a same set of symbols as an associated SSB location or occupies a set of symbols associated with a fixed offset from an associated SSB location in accordance with a first rule or assumption. Such a fixed offset may be an offset of 1 symbol, 2 symbols, 3 symbols, 4 symbols, or any other quantity of symbols. The network entity 105 and the UE 115 may determine that the SIB 440 occupies the same set of symbols as the associated SSB location in examples in which the CORESET0/SSB multiplexing pattern 2 or 3 is used and may determine that the SIB 440 occupies a set of symbols associated with the fixed (or signaled) offset from the associated SSB location in examples in which the CORESET0/SSB multiplexing pattern 1 is used.

In some other examples, the network entity 105 and the UE 115 may determine that the SIB 440 occupies a same first set of symbols as the associated SSB location or occupies a first set of symbols associated with a fixed offset from the associated SSB location and also occupies a second set of symbols in accordance with a second rule or assumption. Such a second set of symbols may be within a same SSB periodicity as the associated SSB and the first set of symbols, and also may be fixed. In some aspects, a location of the second set of symbols may depend on a location of the associated SSB (e.g., a location of the associated SSB index). For example, for CORESET0/SSB multiplexing pattern 2, a continuous set of symbols larger than two symbols may not always be possible if all SSBs are transmitted. Accordingly, for some SSB indices, the second set of symbols may be a fixed set of symbols that is non-continuous with the first set of symbols occupied by the associated SSB, with the location of the second set of symbols being defined on a per-SSB index basis.

Additionally, or alternatively, the network entity 105 and the UE 115 may determine the TDRA associated with the SIB 440 in accordance with an indication in the MIB 410. The indication of the MIB 410 may indicate the TDRA associated with the SIB 440, or at least a portion of the TDRA associated with the SIB 440, by indicating one option from a finite set of options or possibilities. Further, the network entity 105 may provide the indication of the TDRA in the MIB 410 by using a reserved entry of the searchSpaceZero IE in the pdcch-ConfigSIB1 field of the MIB 410. For example, for at least CORESET0/SSB multiplexing patterns 2 and 3, the 4 bits of the searchSpaceZero IE may be unused or reserved. Accordingly, at least some of such bits may be used for indicating the coding rate 420 or the TDRA, or both.

In some examples, a starting symbol of the SIB 440 may be fixed relative to an initial symbol of an associated SSB (e.g., the same starting symbol as the first SSB symbol or with a fixed offset relative to the SSB, such as for CORESET0/SSB multiplexing pattern 1) and the MIB 410 may include an indication of a length of the SIB 440 (e.g., a length of the RMSI PDSCH) in accordance with a first signaling mechanism. In other words, the MIB 410 may include an indication of a quantity of symbols of the SIB 440 or of the RMSI PDSCH carrying the SIB 440. In some aspects, the MIB 410 may convey such an indication of the quantity of symbols by indicating one of, for example, two options or possibilities for the quantity of symbols (such that the indication may be a 1-bit indicator). The network entity 105 may provide such an indication in various scenarios, including scenarios in which the network entity 105 refrains from transmitting a full set of SSBs (e.g., transmits less than 64 SSBs), in which case an RMSI PDSCH may sometimes be able to (additionally) occupy the symbols of the next SSB symbol.

In some other examples, a first set of symbols associated with the SIB 440 (or the RMSI PDSCH carrying the SIB 440) may have a fixed TDRA (e.g., the same symbols as occupied by an associated SSB location or a set of symbols associated with a fixed offset from the symbols occupied by the associated SSB location, such as for CORESET0/SSB multiplexing pattern 1) and the MIB 410 may indicate whether a second set of symbols (within the same SSB periodicity) associated with the SIB 440 (or the RMSI PDSCH carrying the SIB 440) exists (e.g., is present) or not in accordance with a second signaling mechanism. In such examples, the network entity 105 may indicate whether the second set of symbols exists or is present in accordance with determining whether the second set of symbols (e.g., a second repetition) is worth the additional overhead. In accordance with indicating the TDRA associated with the SIB 440 by indicating whether a second set of symbols exists or is present, the MIB 410 may include a 1-bit indicator to convey the TDRA.

In some implementations, the network entity 105 or the UE 115, or both, may determine to use one of various possible options or mechanisms for indicating or determining the TDRA associated with the SIB 440 depending on a CORESET0/SSB multiplexing pattern, depending on an SCS pair of (SSB, PDSCH), or depending on both. For example, the network entity 105 or the UE 115, or both, may determine to use a first signaling mechanism for a first CORESET0/SSB multiplexing pattern or a first SCS pair of (SSB, PDSCH) and may determine to use a second signaling mechanism for a second CORESET0/SSB multiplexing pattern or a second SCS pair of (SSB, PDSCH). For further example, the network entity 105 or the UE 115, or both, may determine to use a signaling mechanism for a first CORESET0/SSB multiplexing pattern or a first SCS pair of (SSB, PDSCH) and may determine to use a (fixed or default) rule or assumption for a second CORESET0/SSB multiplexing pattern or a second SCS pair of (SSB, PDSCH). For further example, the network entity 105 or the UE 115, or both, may determine to use a first (fixed or default) rule or assumption for a first CORESET0/SSB multiplexing pattern or a first SCS pair of (SSB, PDSCH) and may determine to use a second (fixed or default) rule or assumption for a second CORESET0/SSB multiplexing pattern or a second SCS pair of (SSB, PDSCH).

In some aspects, the TDRA associated with the SIB 440 may include, indicate, or otherwise be associated with a DMRS mapping to one or multiple sets of symbols allocated to the SIB 440. For example, for TDRA determination based on a rule or assumption or a MIB-based signaling mechanism, the network entity 105 and the UE 115 may support one or more DMRS mapping procedures regarding how a DMRS is to be mapped across one or multiple sets of symbols allocated to the SIB 440. In some implementations, and in examples in which the TDRA associated with the SIB 440 includes multiple sets of symbols (e.g., a first set of symbols and a second set of symbols), each set of symbols may have a separate DMRS (e.g., one symbol DMRS for each set of symbols). The network entity 105 and the UE 115 may support such implementations in various scenarios, including scenarios in which the multiple sets of symbols are non-contiguous (as UE side coherency may not be assumed when there is a time gap between multiple sets of symbols). Further, such implementations may provide gains even in examples in which the multiple sets of symbols are contiguous (e.g., for presence detection of a second set of symbols based on a DMRS detection). In some other implementations, and also in examples in which the TDRA associated with the SIB 440 includes multiple sets of symbols (e.g., a first set of symbols and a second set of symbols), a first set of symbols may include a DMRS and a second set of symbols may exclude a DMRS (e.g., and include exclusively PDSCH data REs). The network entity 105 and the UE 115 may support such implementations in various scenarios, including scenarios in which the multiple sets of symbols are contiguous.

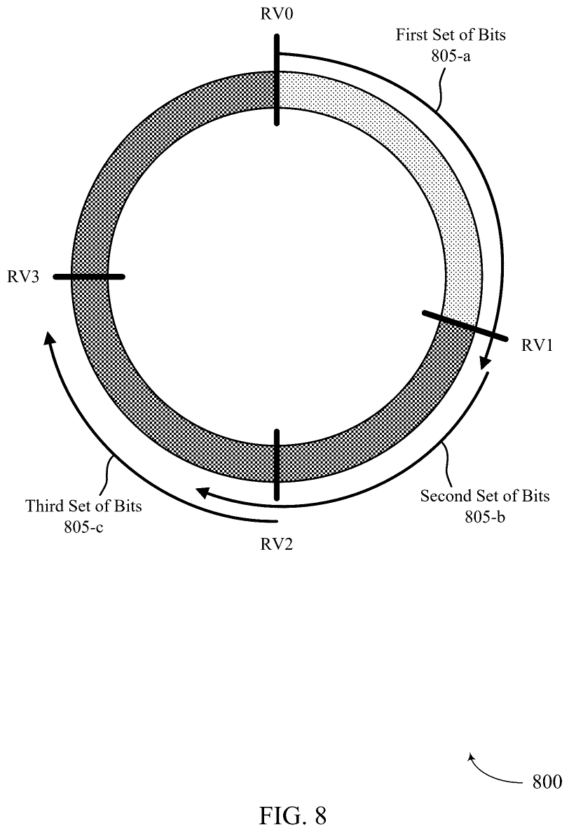

In some aspects, the TDRA associated with the SIB 440 may include, indicate, or otherwise be associated with a PDSCH rate matching protocol or procedure across one or multiple sets of PDSCH symbols. For example, for TDRA determination based on a rule or assumption or a MIB-based signaling mechanism, the network entity 105 and the UE 115 may support one or more PDSCH rate matching procedures regarding how a rate matching from a circular buffer of (coded) bits is to be performed across one or multiple sets of symbols allocated to the SIB 440. Additional details relating to such rate matching procedures are illustrated by and described with reference to FIG. 8.

In some implementations, the network entity 105 and the UE 115 may determine an FDRA associated with the SIB 440 in accordance with one or more fixed, default, or signaled rules or assumptions. For example, the network entity 105 and the UE 115 may determine the FDRA associated with the SIB 440 to be or include an entirety of a CORESET0 or an entirety of an initial downlink BWP in accordance with a rule or assumption. In such examples, the network entity 105 and the UE 115 may determine the FDRA associated with the SIB 440 to be or include 24 RBs or 48 RBs depending on the controlResourceSetZero IE in the pdcch-ConfigSIB1 field in the MIB 410.

Additionally, or alternatively, the network entity 105 and the UE 115 may determine an FDRA associated with the SIB 440 in accordance with an indication in the MIB 410. The indication of the MIB 410 may indicate the FDRA associated with the SIB 440, or at least a portion of the FDRA associated with the SIB 440, by indicating one option from a finite set of options or possibilities. For example, the indication of the FDRA associated with the SIB 440 (or of the RMSI PDSCH carrying the SIB 440) may indicate one of two possible FDRAs (such that the indication of the FDRA may be a 1-bit indicator) in accordance with a first signaling mechanism. Such two possible FDRAs may include, for example, {first half of CORESET0 RBs, second half of CORESET0 RBs}; or {first half of CORESET0 RBs, all RBs of CORESET0}; or {even RB indices of CORESET0 RBs, odd RB indices of CORESET0 RBs}; or {even RB indices of CORESET0 RBs, all RBs of CORESET0}; among other examples. For further example, the indication of the FDRA associated with the SIB 440 (or of the RMSI PDSCH carrying the SIB 440) may indicate one of three possible FDRAs (such that the indication of the FDRA may be a 2-bit indicator) in accordance with a second signaling mechanism. Such three possible FDRAs may include, for example, {first half of CORESET0 RBs, second half of CORESET0 RBs, all RBs of CORESET0}; or {even RB indices of CORESET0 RBs, odd RB indices of CORESET0 RBs, all RBs of CORESET0}, among other examples.

In some examples, one or more reserved entries of the controlResourceSetZero IE in the pdcch-ConfigSIB1 field in the MIB 410 may include such an indication of the FDRA associated with the SIB 440. By indicating the FDRA associated with the SIB 440 via the MIB 410, the network entity 105 and the UE 115 may support techniques according to which other broadcast PDSCHs (e.g., paging PDSCH, OSI PDSCH, random access response (RAR) PDSCH, etc.) can also be sent via the same set of symbols as the RMSI PDSCH (e.g., in a frequency division multiplexed manner). Further, by indicating the FDRA associated with the SIB 440 via the MIB 410, the network entity 105 may select different RB sizes depending on the SIB 440 payload size or depending on the RMSI PDSCH TBS.

Tables 1 and 2, shown below, illustrate example signaling mechanisms associated with indicating an FDRA via the MIB 410 by using one or more reserved entries associated with the controlResourceSetZero IE. In some aspects, Table 1 illustrates an example scenario of a CORESET0/SSB multiplexing pattern 2 and (SSB, RMSI PDCCH/PDSCH) SCS is (240, 120) kHz. In some aspects, Table 2 illustrates an example scenario of a CORESET0/SSB multiplexing pattern 3 and (SSB, RMSI PDCCH/PDSCH) SCS is (120, 120) kHz.

TABLE 1
Set of resource blocks and slot symbols of CORESET
for Type0-PDCCH search space set when (SS/PBCH
block, PDCCH) SCS is (240, 120) kHz

| | SS/PBCH block and | | | |
|---|---|---|---|---|
| | CORESET | Number of | Number of | |
| Index | multiplexing pattern | RBs | Symbols | Offset (RBs) |
| 0 | 1 | 48 | 1 | 0 |
| 1 | 1 | 48 | 1 | 8 |
| 2 | 1 | 48 | 2 | 0 |
| 3 | 1 | 48 | 2 | 8 |
| 4 | 2 | 24 | 1 | −41 if k_{SSB} = 0; |
| | | | | −42 if k_{SSB} > 0 |
| 5 | 2 | 24 | 1 | 25 |
| 6 | 2 | 48 | 1 | −41 if k_{SSB} = 0; |
| | | | | −42 if k_{SSB} > 0 |
| 7 | 2 | 48 | 1 | 49 |

| | |
|---|---|
| 8 | Reserved |
| 9 | Reserved |
| 10 | Reserved |
| 11 | Reserved |
| 12 | Reserved |
| 13 | Reserved |
| 14 | Reserved |
| 15 | Reserved |

TABLE 2
Set of resource blocks and slot symbols of CORESET
for Type0-PDCCH search space set when (SS/PBCH
block, PDCCH) SCS is (120, 120) kHz

| | SS/PBCH block and | | | |
|---|---|---|---|---|
| | CORESET | Number of | Number of | |
| Index | multiplexing pattern | RBs | Symbols | Offset (RBs) |
| 0 | 1 | 24 | 2 | 0 |
| 1 | 1 | 24 | 2 | 4 |
| 2 | 1 | 48 | 1 | 14 |
| 3 | 1 | 48 | 2 | 14 |
| 4 | 3 | 24 | 2 | −20 if k_{SSB} = 0; |
| | | | | −21 if k_{SSB} > 0 |
| 5 | 3 | 24 | 2 | 24 |
| 6 | 3 | 48 | 2 | −20 if k_{SSB} = 0; |
| | | | | −21 if k_{SSB} > 0 |
| 7 | 3 | 48 | 2 | 48 |

| | |
|---|---|
| 8 | Reserved |
| 9 | Reserved |
| 10 | Reserved |
| 11 | Reserved |
| 12 | Reserved |
| 13 | Reserved |
| 14 | Reserved |
| 15 | Reserved |

For example, an index within the range of indices 4-7, as shown in Tables 1 and 2, may indicate that an entirety of (e.g., all RBs) of CORESET0 are used for the RMSI PDSCH. For further example, an index within the range of indices 8-11, as shown in Tables 1 and 2, may indicate a same CORESET0 configuration as for indices 4-7 with a first (e.g., lowest in frequency or highest in frequency) half of the RBs of CORESET0 being used for the RMSI PDSCH. For further example, an index within the range of indices 12-15, as shown in Tables 1 and 2, may indicate a same CORESET0 configuration as for indices 4-7 with a second (e.g., highest in frequency or lowest in frequency) half of the RBs of CORESET0 being used for the RMSI PDSCH.

In some implementations, the network entity 105 or the UE 115, or both, may determine to use one of various possible options or mechanisms for indicating or determining the FDRA associated with the SIB 440 depending on a CORESET0/SSB multiplexing pattern, depending on an SCS pair of (SSB, PDSCH), or depending on both. For example, the network entity 105 or the UE 115, or both, may determine to use a first signaling mechanism for a first CORESET0/SSB multiplexing pattern or a first SCS pair of (SSB, PDSCH) and may determine to use a second signaling mechanism for a second CORESET0/SSB multiplexing pattern or a second SCS pair of (SSB, PDSCH). For further example, the network entity 105 or the UE 115, or both, may determine to use a signaling mechanism for a first CORESET0/SSB multiplexing pattern or a first SCS pair of (SSB, PDSCH) and may determine to use a (fixed or default) rule or assumption for a second CORESET0/SSB multiplexing pattern or a second SCS pair of (SSB, PDSCH).

In some implementations, the network entity 105 and the UE 115 may determine a VRB-to-PRB mapping 430 associated with the SIB 440 in accordance with one or more fixed, default, or signaled rules or assumptions. For example, the network entity 105 and the UE 115 may assume a non-interleaved mapping or may assume an interleaved mapping associated with the VRBs/PRBs associated with the SIB 440 in accordance with a fixed rule or assumption. For example, in implementations in which the FDRA associated with the SIB 440 includes all RBs, even RBs, or odd RBs of CORESET0, interleaving may not provide additional frequency diversity gain. Accordingly, in such examples, the network entity 105 and the UE 115 may assume a non-interleaved mapping for the VRB-to-PRB mapping 430.

Additionally, or alternatively, the MIB 410 may include an indication of the VRB-to-PRB mapping 430. In some examples, the network entity 105 may include an indication of the VRB-to-PRB mapping 430 associated with the SIB 440 in implementations in which the FDRA associated with the SIB 440 includes a first or second half of the RBs of CORESET0 (with the first or second half of RBs of CORESET0, as determined in accordance with a rule or indicated by the MIB 410, being in the VRB domain). In examples in which the MIB 410 includes an indication of the VRB-to-PRB mapping 430, the network entity 105 may transmit or provide the indication in accordance with using one or more reserved entries of the controlResourceSetZero IE in the pdcch-ConfigSIB1 field in the MIB 410 (in addition to, or as an alternative to, an FDRA indication in the MIB 410).

In some implementations, the network entity 105 and the UE 115 may determine a set of RVs 435 associated with the SIB 440 in accordance with one or more fixed, default, or signaled rules or assumptions. In such implementations, the network entity 105 and the UE 115 may determine an RV, from the set of RVs 435, as (e.g., in accordance with) a function of RMSI PDSCH location in time (e.g., in accordance with or based on one or more of an SFN, a subframe index within a frame, a slot index, or a starting symbols index of PDSCH). In other words, the network entity 105 and the UE 115 may perform RV cycling across the set of RVs 435 as determined in accordance with the rule or assumption. In examples in which the set of RVs 435 includes four RVs, the network entity 105 and the UE 115 may cycle through the set of RVs 435 after, for example, four SSB periodicities (e.g., in 80 milliseconds). For example, the network entity 105 and the UE 115 may cycle between using RV=0 for a first SIB 440 (in a first SSB period), using RV=2 for a second SIB 440 (in a second SSB period), using RV=3 for a third SIB 440 (in a third SSB period), and using RV=1 for a fourth SIB 440 (in a fourth SSB period). In a fifth SSB period, the network entity 105 and the UE 115 may again use RV=0 (e.g., the RV cycling may repeat over time).

Additionally, or alternatively, the network entity 105 and the UE 115 may determine the set of RVs 435 associated with the SIB 440 in accordance with an indication in the MIB 410. For example, the MIB 410 may indicate the set of RVs 435 to cycle through. In some implementations, the MIB 410 may indicate the set of RVs 435 to cycle through by indicating one option from a finite set of options or possibilities. For example, the network entity 105 may select to indicate that the set of RVs 435 is {0, 2, 3, 1} or {0, 3} through a 1-bit indicator in the MIB 410. In accordance with communication of the MIB 410, the network entity 105 and the UE 115 may cycle between RVs of the set of RVs 435 indicated by the MIB 410. The network entity 105 and the UE 115 may determine an RV, from the set of RVs 435, as (e.g., in accordance with) a function of RMSI PDSCH location in time (e.g., in accordance with or based on one or more of an SFN, a subframe index within a frame, a slot index, or a starting symbols index of PDSCH).

In accordance with indicating the set of RVs 435 via the MIB 410, the network entity 105 may switch between different sets of RVs 435 in accordance with a tradeoff or balance between coding rate and latency. For example, with RV cycling between a set of RVs 435 of {0, 2, 3, 1}, a higher coding rate may be achieved at the potential cost of added latency (as RVs 2 and 1 may not be self-decodable). For further example, with RV cycling between a set of RVs 435 of {0, 3}, latency may be reduced but coding gain may potentially be adversely impacted. In some aspects, the MIB 410 may indicate the set of RVs 435 across which the network entity 105 and the UE 115 may cycle, as opposed to indicating a specific RV directly (for the RMSI PDSCH in that SSB period), to avoid scenarios in which a payload of the MIB 410 changes across SSB periods. By maintaining a same payload of the MIB 410 across SSB periods, the UE 115 may have a greater likelihood of successfully soft combining MIB/PBCH across two or more SSB periods.

In some implementations, the network entity 105 and the UE 115 may support one or more signaling- or configuration-based mechanisms according to which the UE 115 may determine, detect, identify, or otherwise ascertain whether an SIB 440 is actually transmitted via a particular RMSI PDSCH occasion. In some examples, the UE 115 may determine that a SIB 440 is transmitted via a set of RMSI PDSCH occasions (e.g., every RMSI PDSCH occasion) in accordance with a (fixed, default, or signaled) rule or assumption. In some other examples, the UE 115 may determine whether a SIB 440 is actually transmitted via a particular RMSI PDSCH occasion in accordance with whether one or more conditions are satisfied. As described herein, a satisfaction of a condition may indicate, to the UE 115, that a SIB 440 is transmitted or that a SIB 440 is not transmitted. Whether a satisfaction of a condition indicates that a SIB 440 is transmitted or that a SIB 440 is not transmitted may depend on the context.

In some aspects, such one or more conditions may include conditions associated with a detection of a DCI scheduling another PDSCH transmission or a physical uplink shared channel (PUSCH) transmission. For example, the UE 115 may determine or assume that a SIB 440 is not transmitted (e.g., absent) via a particular RMSI PDSCH occasion if the UE 115 detects a DCI with CRC scrambled with P-RNTI and the time/frequency resources of the scheduled paging PDSCH at least partially overlap with the time/frequency resources of the RMSI PDSCH, if the UE 115 detects a DCI with CRC scrambled with RA-RNTI and the time/frequency resources of the scheduled RAR PDSCH at least partially overlap with the time/frequency resources of the RMSI PDSCH, if the UE 115 detects a DCI with CRC scrambled with TC-RNTI and the time/frequency resources of the scheduled MSG4 PDSCH or MSG3 PUSCH at least partially overlap with the time/frequency resources of the RMSI PDSCH, or if the UE 115 is in an RRC connected state and if the UE 115 detects a DCI with CRC scrambled with C-RNTI and the time/frequency resources of the scheduled PDSCH/PUSCH at least partially overlap with the time/frequency resources of the RMSI PDSCH. Additionally, or alternatively, the time/frequency resources of a detected DCI itself may also be considered, by the UE 115, to determine whether the RMSI PDSCH occasion is present.

Additionally, or alternatively, such one or more conditions may include conditions associated with an absence of a detection of a DMRS of the RMSI PDSCH. For example, the UE 115 may determine or assume that a SIB 440 is not transmitted (e.g., absent) via a particular RMSI PDSCH occasion if the UE 115 does not detect the presence of a DMRS associated with the SIB 440 or the RMSI PDSCH carrying the SIB 440. In some implementations, the network entity 105 and the UE 115 may determine a DMRS sequence for an RMSI PDSCH in accordance with a specific scrambling identifier that is different than a scrambling identifier used for other PDSCHs (e.g., paging PDSCHs, RAR PDSCHs, etc.). By using a different DMRS sequence for RMSI PDSCHs, the UE 115 may reliably detect a presence or an absence of the RMSI PDSCH. For example, the UE 115 may correlate a received DMRS with a first DMRS sequence associated with RMSI PDSCHs and a second DMRS sequence associated with other PDSCHs and may determine whether the PDSCH via which the DMRS is received is an RMSI PDSCH or another type of PDSCH in accordance with which of the first DMRS sequence or the second DMRS sequence results in a greater correlation. In some aspects, the network entity 105 and the UE 115 may use a relatively large (e.g., complete or entire, with respect to the CORESET0 or the initial downlink BWP, such as all RBs of CORESET0) set of RBs for the RMSI PDSCH to facilitate relatively more accurate DMRS-based presence detection based on a unique DMRS sequence.

Additionally, or alternatively, such one or more conditions may include conditions associated with an indication in the MIB 410. For example, in a given SSB periodicity, the MIB 410 may indicate whether an RMSI PDSCH in the same SSB period or in a next SSB period is transmitted (e.g., the MIB 410 may indicate whether the SIB 440 is actually transmitted via the RMSI PDSCH in the same SSB period or in a next SSB period). In some implementations, such an indication in the MIB 410 may apply to multiple RMSI PDSCH occasions, such as to a next M RMSI PDSCH occasions. A value of M may be fixed or may be indicated by the MIB 410. In some aspects, such a set of next M RMSI PDSCH occasions may be associated with a same SSB index as the MIB 410 providing the indication (e.g., within M SSB periods). Additionally, or alternatively, the MIB 410 may indicate a transmission pattern of RMSI PDSCHs across multiple SSB periods (e.g., with such multiple SSB periods including even SSB periods, odd SSB periods, or all SSB periods, among other examples). If a SIB 440 is not transmitted in one or more SSB periods (as indicated by the MIB 410, or otherwise), the RV pattern/cycling for SIBs 440 associated with that SSB index may be across different SSB periods regardless of whether a SIB 440 is actually transmitted or may be across different SSB periods within which a SIB 440 is actually transmitted (as indicated by the MIB 410, or otherwise).

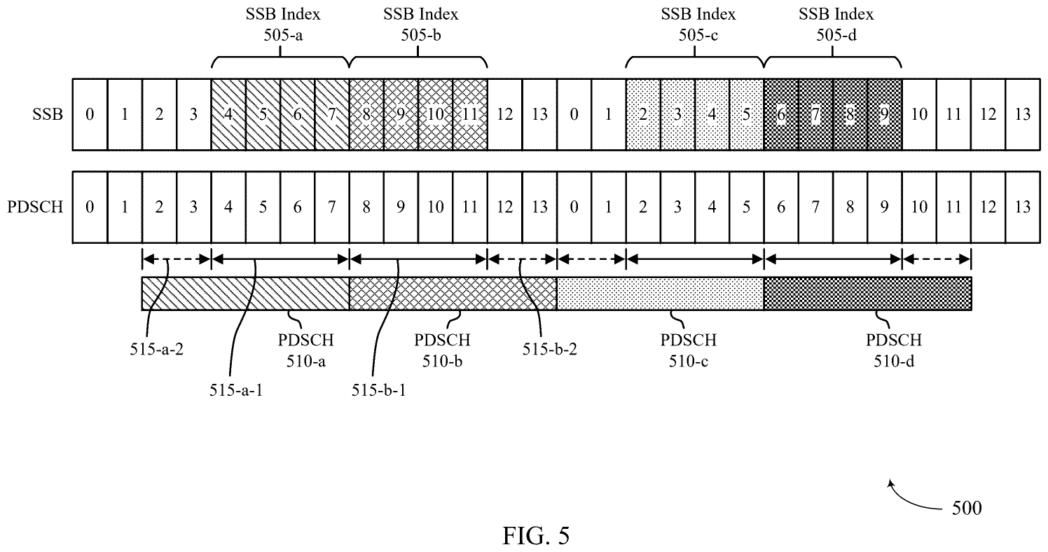

FIG. 5 shows an example of a TDRA scheme 500 that supports communication of system information via a PDSCH in accordance with information provided by a MIB in accordance with one or more aspects of the present disclosure. In some implementations, the TDRA scheme 500 may illustrate examples in which a TDRA associated with a SIB, such as the SIB 440 as illustrated by and described with reference to FIG. 4, includes a first set of symbols and (conditionally or selectively, such as based on a rule or an indication in a MIB) includes a second set of symbols.

As illustrated by the example of the TDRA scheme 500, an SSB index 505-a may be associated with a PDSCH 510-a, an SSB index 505-b may be associated with a PDSCH 510-b, an SSB index 505-c may be associated with a PDSCH 510-c, and an SSB index 505-d may be associated with a PDSCH 510-d. The TDRA scheme 500 may further be associated with a CORESET0/SSB multiplexing pattern 3 (in an example of (120, 120) kHz SCS for (SSB, PDSCH), respectively). Each of the PDSCH 510-a, the PDSCH 510-b, the PDSCH 510-c, and the PDSCH 510-d may be an example of an RMSI PDSCH carrying a SIB, such as SIB1.

For the RMSI PDSCH associated with each SSB index, the RMSI PDSCH may include at least a first set of symbols (illustrated in the example of the TDRA scheme 500 by solid double-arrowed lines) and may (conditionally) include a second set of symbols (illustrated in the example of the TDRA scheme 500 by dashed double-arrowed lines). For example, the PDSCH 510-a may include (e.g., span) at least a first set of symbols 515-a-1 and may (conditionally, such as based on a rule or an indication in a MIB) include a second set of symbols 515-a-2. For further example, the PDSCH 510-b may include (e.g., span) at least a first set of symbols 515-b-1 and may (conditionally, such as based on a rule or an indication in a MIB) include a second set of symbols 515-b-2.

In the example of the TDRA scheme 500, the first set of symbols associated with each RMSI PDSCH may be contiguous with the second set of symbols associated with that RMSI PDSCH (for each of the SSB index 505-a, the SSB index 505-b, the SSB index 505-c, and the SSB index 505-d). In some implementations, the second set of symbols associated with each RMSI PDSCH may (e.g., always) be present by default. In some other implementations, the second set of symbols associated with a given RMSI PDSCH may be conditionally present in accordance with an indication in a corresponding MIB or in accordance with a rule, or both.

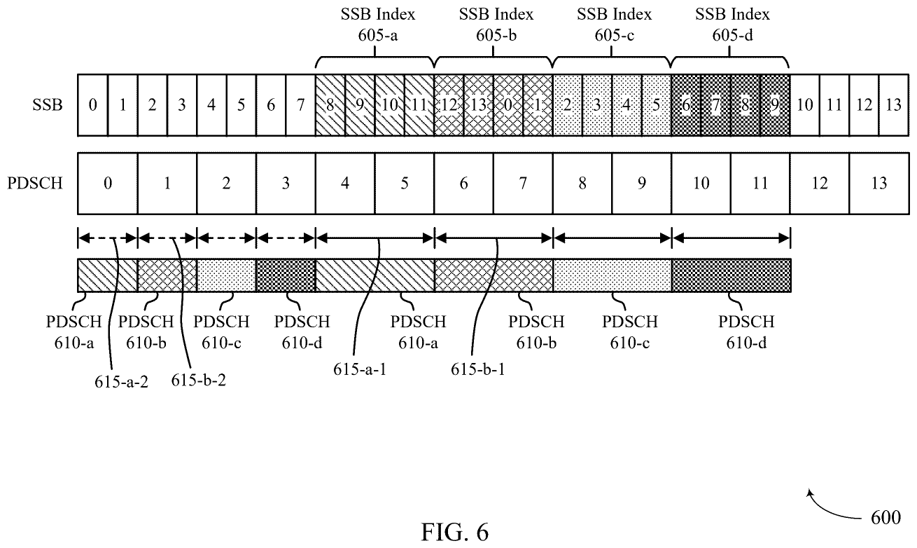

FIG. 6 shows an example of a TDRA scheme 600 that supports communication of system information via a PDSCH in accordance with information provided by a MIB in accordance with one or more aspects of the present disclosure. In some implementations, the TDRA scheme 600 may illustrate examples in which a TDRA associated with a SIB, such as the SIB 440 as illustrated by and described with reference to FIG. 4, includes a first set of symbols and (conditionally or selectively, such as based on a rule or an indication in a MIB) includes a second set of symbols.

As illustrated by the example of the TDRA scheme 600, an SSB index 605-a may be associated with a PDSCH 610-a, an SSB index 605-b may be associated with a PDSCH 610-b, an SSB index 605-c may be associated with a PDSCH 610-c, and an SSB index 605-d may be associated with a PDSCH 610-d. The TDRA scheme 600 may further be associated with a CORESET0/SSB multiplexing pattern 2 (in an example of (240, 120) kHz SCS for (SSB, PDSCH), respectively). Each of the PDSCH 610-a, the PDSCH 610-b, the PDSCH 610-c, and the PDSCH 610-d may be an example of an RMSI PDSCH carrying a SIB, such as SIB1.

For the RMSI PDSCH associated with each SSB index, the RMSI PDSCH may include at least a first set of symbols (illustrated in the example of the TDRA scheme 600 by solid double-arrowed lines) and may (conditionally) include a second set of symbols (illustrated in the example of the TDRA scheme 600 by dashed double-arrowed lines). For example, the PDSCH 610-a may include at least a first set of symbols 615-a-1 and may (conditionally, such as based on a rule or an indication in a MIB) include a second set of symbols 615-a-2. For further example, the PDSCH 610-b may include at least a first set of symbols 615-b-1 and may (conditionally, such as based on a rule or an indication in a MIB) include a second set of symbols 615-b-2.

In the example of the TDRA scheme 600, the first set of symbols associated with each RMSI PDSCH may be non-contiguous with the second set of symbols associated with that RMSI PDSCH (for each of the SSB index 605-a, the SSB index 605-b, the SSB index 605-c, and the SSB index 605-d). In some aspects, the two sets of symbols may be con-contiguous due to the second set of symbols occupying a same (time domain) location as a corresponding SSS0 would have otherwise occupied. In some implementations, the second set of symbols associated with each RMSI PDSCH may (e.g., always) be present by default. In some other implementations, the second set of symbols associated with a given RMSI PDSCH may be conditionally present in accordance with an indication in a corresponding MIB or in accordance with a rule, or both.

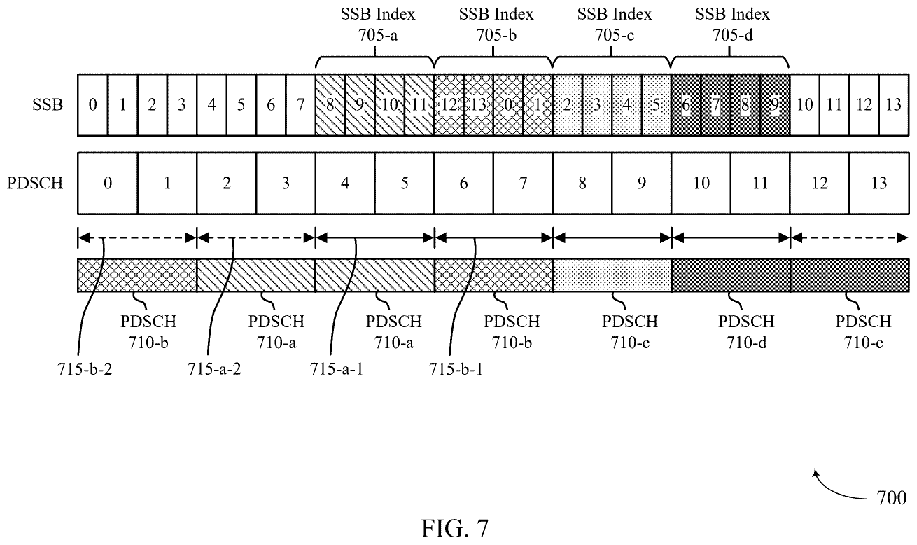

FIG. 7 shows an example of a TDRA scheme 700 that supports communication of system information via a PDSCH in accordance with information provided by a MIB in accordance with one or more aspects of the present disclosure. In some implementations, the TDRA scheme 700 may illustrate examples in which a TDRA associated with a SIB, such as the SIB 440 as illustrated by and described with reference to FIG. 4, includes a first set of symbols and (conditionally or selectively, such as based on a rule or an indication in a MIB) includes a second set of symbols.

As illustrated by the example of the TDRA scheme 700, an SSB index 705-a may be associated with a PDSCH 710-a, an SSB index 705-b may be associated with a PDSCH 710-b, an SSB index 705-c may be associated with a PDSCH 710-c, and an SSB index 705-d may be associated with a PDSCH 710-d. The TDRA scheme 700 may further be associated with a CORESET0/SSB multiplexing pattern 2 (in an example of (240, 120) kHz SCS for (SSB, PDSCH), respectively). Each of the PDSCH 710-a, the PDSCH 710-b, the PDSCH 710-c, and the PDSCH 710-d may be an example of an RMSI PDSCH carrying a SIB, such as SIB1.

For the RMSI PDSCH associated with each SSB index, the RMSI PDSCH may include at least a first set of symbols (illustrated in the example of the TDRA scheme 700 by solid double-arrowed lines) and may (conditionally) include a second set of symbols (illustrated in the example of the TDRA scheme 700 by dashed double-arrowed lines). For example, the PDSCH 710-a may include at least a first set of symbols 715-a-1 and may (conditionally, such as based on a rule or an indication in a MIB) include a second set of symbols 715-a-2. For further example, the PDSCH 710-b may include at least a first set of symbols 715-b-1 and may (conditionally, such as based on a rule or an indication in a MIB) include a second set of symbols 715-b-2.

In the example of the TDRA scheme 700, the first set of symbols associated with an RMSI PDSCH may be contiguous with the second set of symbols associated with the RMSI PDSCH for some SSB indices and may be non-contiguous with the second set of symbols associated with the RMSI PDSCH for some other SSB indices. For example, the respective first set of symbols and the respective second set of symbols associated with each of the PDSCH 710-a and the PDSCH 710-d may be contiguous. For further example, the respective first set of symbols and the respective second set of symbols associated with each of the PDSCH 710-b and the PDSCH 710-c may be non-contiguous. Further, although a second set of symbols associated with the PDSCH 710-c are not shown in the TDRA scheme 700, such a second set of symbols may precede or follow the symbols shown in the TDRA scheme 700. In some implementations, the second set of symbols associated with each RMSI PDSCH may (e.g., always) be present by default. In some other implementations, the second set of symbols associated with a given RMSI PDSCH may be conditionally present in accordance with an indication in a corresponding MIB or in accordance with a rule, or both.

FIG. 8 shows an example of a circular buffer 800 that supports communication of system information via a PDSCH in accordance with information provided by a MIB in accordance with one or more aspects of the present disclosure. The circular buffer 800 may illustrate various implementations according to which a network entity 105 may select bits for a SIB, such as the SIB 440 (e.g., a SIB1) as illustrated by and described with reference to FIG. 4, in accordance with a rate matching procedure across multiple sets of PDSCH symbols. Such multiple sets of PDSCH symbols may include a first set of symbols associated with an RMSI PDSCH and a second set of symbols associated with the RMSI PDSCH, among other examples.

In examples in which an RMSI PDSCH includes a first set of symbols and a second set of symbols, the network entity 105 and the UE 115 may support one or more of various rate matching procedures for the RMSI PDSCH (e.g., the SIB1). Additional details relating to such a first set of symbols and a second set of symbols associated an RMSI PDSCH are illustrated by and described with reference to FIGS. 5-7. In some implementations, the network entity 105 or the UE 115, or both, may continue rate matching from the circular buffer 800 across the two sets of symbols, with a starting coded bit from the circular buffer 800 being associated with (e.g., based on) the RV of the SIB1. In such implementations, the network entity 105 or the UE 115, or both, may start with the first set of symbols (even, for example, if the second set of symbols are earlier than the first set of symbols) or may start with an earlier set of symbols between the first and second sets of symbols. In such implementations, TBS determination may be based on the resources in both sets of symbols. In accordance with continuous rate matching from the circular buffer 800 across the two sets of symbols, the network entity 105 or the UE 115, or both, may map a first set of bits 805-a to one of the first or second set of symbols and may map a second set of bits 805-b to the other of the first and second sets of symbols, with the second set of bits 805-b being continuous (e.g., contiguous) with the first set of bits 805-a.

In some other implementations, the network entity 105 or the UE 115, or both, may perform separate rate matching for each set of symbols with a starting coded bit associated with (e.g., based on) an associated RV. In such implementations, the first set of symbols may correspond to a first repetition (of the SIB1) with a first RV and the second set of symbols may correspond to a second repetition (of the SIB1) with a second RV. In some examples, the second RV may be a function of the first RV. For example, if the first RV=0, the second RV=2. For further example, if the first RV=1, the second RV=3. In such implementations, TBS determination may be based on the resources in one of the repetitions (e.g., based on the first repetition or based on the earlier repetition, among other examples). In accordance with separate rate matching from the circular buffer 800 across the two sets of symbols, the network entity 105 or the UE 115, or both, may map the first set of bits 805-a to one of the first or second set of symbols and may map a third set of bits 805-c to the other of the first and second sets of symbols, with the first set of bits 805-a being associated with (e.g., starting from) a first RV (e.g., RV=0) and with the third set of bits 805-c being associated with (e.g., starting from) a second RV (e.g., RV=2). The first set of bits 805-a and the third set of bits 805-c may be non-continuous (e.g., non-contiguous) sets of bits from the circular buffer 800.

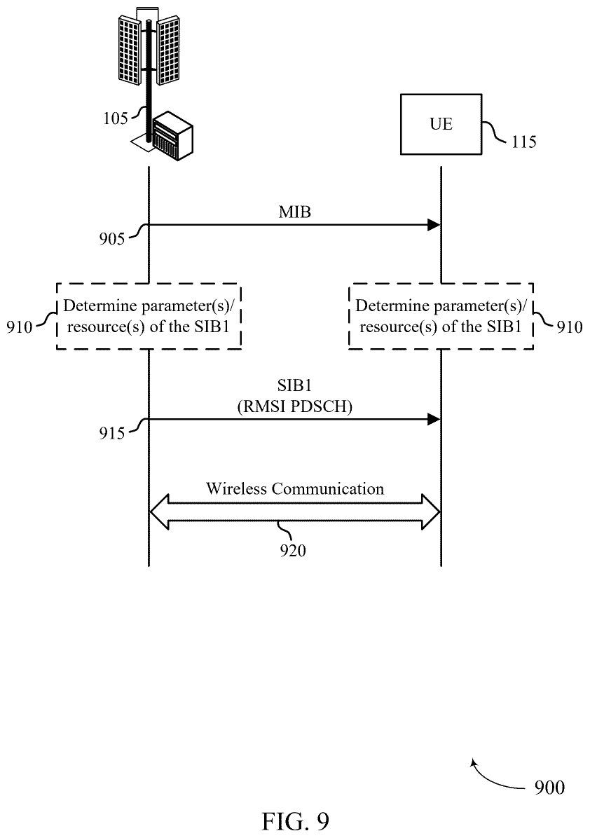

FIG. 9 shows an example of a process flow 900 that supports communication of system information via a PDSCH in accordance with information provided by a MIB in accordance with one or more aspects of the present disclosure. The process flow 900 illustrates communication between a network entity 105 and a UE 115, which may be examples of corresponding devices described herein, including a network entity 105 and a UE 115 as illustrated by or described with reference to FIGS. 1-8. In some implementations, the network entity 105 and the UE 115 may support one or more signaling- or configuration-based mechanisms according to which the network entity 105 and the UE 115 may achieve greater RMSI PDSCH coverage by refraining from communicating (e.g., transmitting or receiving) an RMSI PDCCH and by re-purposing one or more PDCCH REs for the RMSI PDSCH.

Alternative examples of the following may be implemented. Some steps are performed in a different order than described or are not performed at all. In some implementations, steps may include additional features not mentioned below, or further steps may be added. Further, although example devices are shown performing the operations of the process flow 900, some aspects of some operations also may be performed by one or more other wireless communication devices without exceeding the scope of the present disclosure.

At 905, the network entity 105 may transmit (e.g., broadcast) a MIB. the network entity 105 may transmit the MIB via a PBCH as part of, for example, an SSB/PBCH transmission. In some aspects, the MIB may be associated with a specific SSB index. In some implementations, the MIB may indicate one or more communication parameters associated with the network entity 105 and may include an indication of a coding rate of a SIB1 associated with (e.g., to be transmitted by) the network entity 105. Such one or more communication parameters may include or indicate one or more of an SFN (via a systemFrameNumber field or parameter), an SCS (via a subCarrierSpacingCommon field or parameter), an SSB subcarrier offset (via an ssb-SubcarrierOffset field or parameter), a DMRS position (via a dmrs-TypeA-Position field or parameter), a PDCCH configuration (via a pdcch-ConfigSIB1 field or field or parameter), a cell barred indication (via a cellbarred field or parameter), or an intra-frequency reselection indication (via an intraFreqReselection field or parameter). The PDCCH configuration may be present, absent, partially re-purposed, or fully re-purposed in accordance with the absence of an RMSI PDCCH scheduling SIB1. The coding rate indicated by the MIB may indicate or define a ratio between a quantity of useful bits and a quantity of total transmitted bits associated with the SIB1.

At 910, the network entity 105 or the UE 115, or both, may determine one or more parameters or resources of the SIB1 associated with (e.g., to be transmitted by) the network entity 105. For example, in association with receiving the MIB (indicating the coding rate of the SIB1), the UE 115 may obtain, identify, select, calculate, receive information indicative of, or otherwise determine one or more parameters or resources of the SIB1 associated with (e.g., to be transmitted by) the network entity 105. Such one or more parameters or resources may include the coding rate (which may be indicated by the MIB), a TDRA associated with the SIB1, an FDRA associated with the SIB1, a VRB-to-PRB mapping associated with the SIB1, or a set of RVs associated with the SIB1, among other examples, or any combination thereof. The network entity 105 or the UE 115 may determine the one or more parameters or resources associated with the SIB1 in accordance with information (e.g., one or more indications) included within the MIB, in accordance with one or more (fixed, default, or signaled) rules or assumptions, or any combination thereof. The network entity 105 or the UE 115 may use (e.g., activate and employ) such rule(s) or assumption(s) in accordance with the MIB indicating the coding rate of the SIB1.

At 915, the network entity 105 may transmit the SIB1 (e.g., an RMSI PDSCH message). The network entity 105 may transmit the SIB1 via a PDSCH, which may be referred to herein as an RMSI PDSCH. The network entity 105 may transmit the SIB1 in accordance with the one or more parameters or resources of the SIB1 as indicated at 905 or as determined at 910. The UE 115 may receive the SIB1 in accordance with the one or more parameters or resources of the SIB1 as indicated at 905 or as determined at 910. For example, the UE 115 may receive the SIB1 in accordance with the coding rate indicated by the MIB. The SIB1 may indicate one or more system information parameters associated with communication with the network entity 105. For example, the SIB1 may indicate information associated with an availability or scheduling of one or more other SIBs and may indicate whether the other SIBs are provided via periodic broadcast or on-demand. Additionally, or alternatively, the SIB1 may indicate cell selection information, cell access information, or a serving cell configuration, among other examples. Generally, the MIB and the SIB1, collectively, may provide sufficient information to the UE 115 to establish a connection (e.g., an RRC connection, as the UE 115 may be an in RRC idle or inactive state when receiving the MIB and the SIB1) with the network entity 105.

At 920, the network entity 105 and the UE 115 may perform wireless communication in accordance with the communication parameters indicated by the MIB and the system information parameters provided by the SIB1. Such wireless communication may include communication (e.g., transmission or reception) of one or more other SIBs, random access messages, paging messages, data messages, or control messages, among other examples, or any combination thereof.

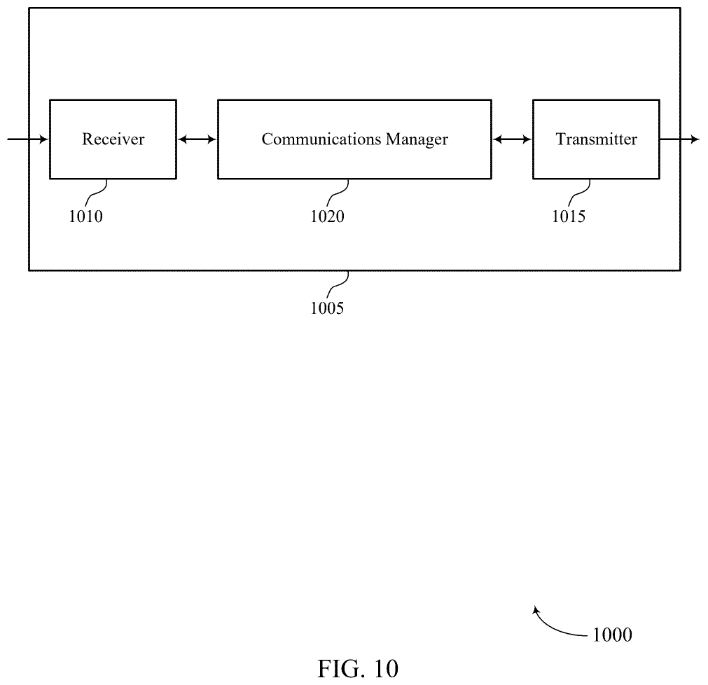

FIG. 10 shows a block diagram 1000 of a device 1005 that supports communication of system information via a PDSCH in accordance with information provided by a MIB in accordance with one or more aspects of the present disclosure. The device 1005 may be an example of aspects of a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to communication of system information via a PDSCH in accordance with information provided by a MIB). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to communication of system information via a PDSCH in accordance with information provided by a MIB). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations or components thereof may be examples of means for performing various aspects of communication of system information via a PDSCH in accordance with information provided by a MIB as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. For example, the communications manager 1020 is capable of, configured to, or operable to support a means for receiving, via a PBCH, a MIB that indicates one or more communication parameters associated with a network entity and that includes an indication of a coding rate of a SIB associated with the network entity. The communications manager 1020 is capable of, configured to, or operable to support a means for receiving, via a PDSCH, the SIB in accordance with the coding rate indicated by the MIB.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources.

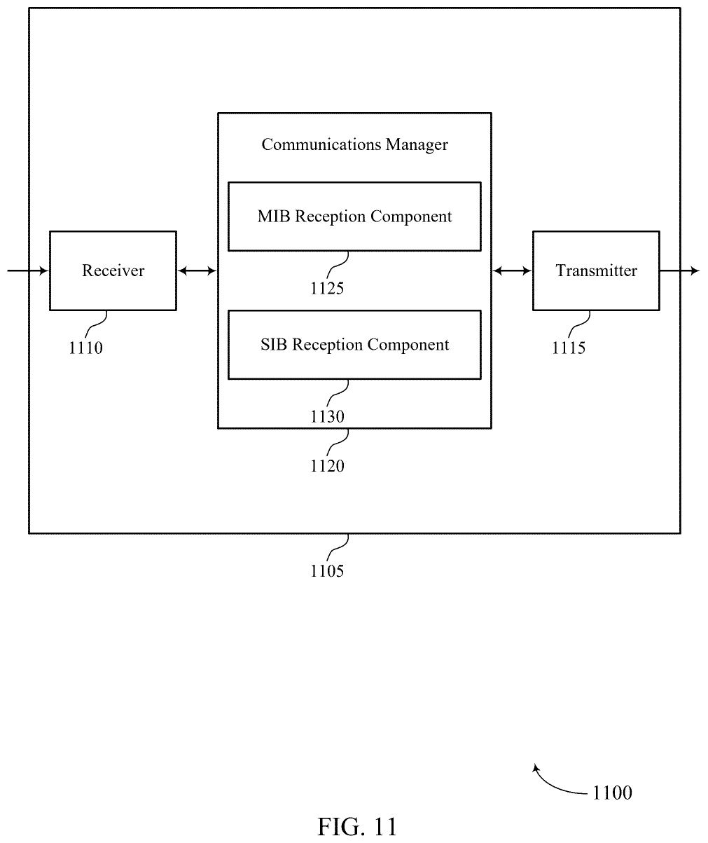

FIG. 11 shows a block diagram 1100 of a device 1105 that supports communication of system information via a PDSCH in accordance with information provided by a MIB in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to communication of system information via a PDSCH in accordance with information provided by a MIB). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to communication of system information via a PDSCH in accordance with information provided by a MIB). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of communication of system information via a PDSCH in accordance with information provided by a MIB as described herein. For example, the communications manager 1120 may include a MIB reception component 1125 an SIB reception component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. The MIB reception component 1125 is capable of, configured to, or operable to support a means for receiving, via a PBCH, a MIB that indicates one or more communication parameters associated with a network entity and that includes an indication of a coding rate of a SIB associated with the network entity. The SIB reception component 1130 is capable of, configured to, or operable to support a means for receiving, via a PDSCH, the SIB in accordance with the coding rate indicated by the MIB.

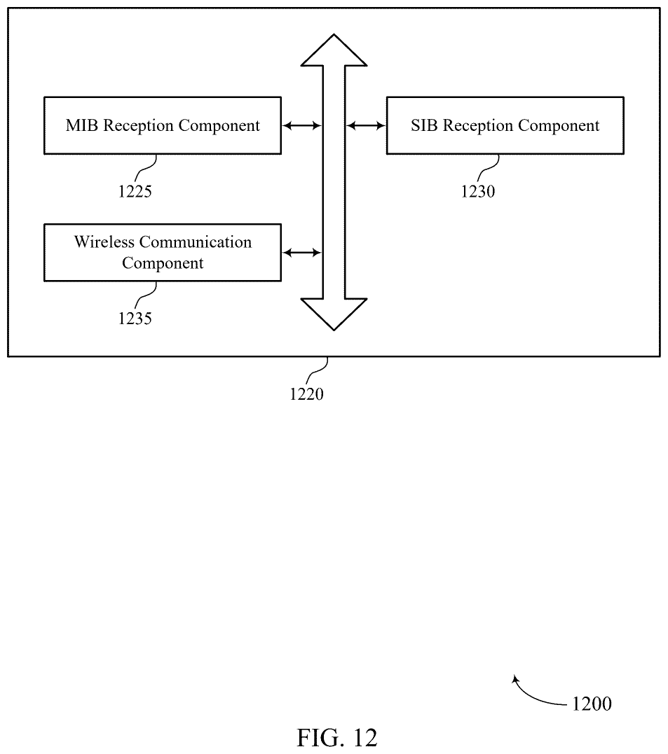

FIG. 12 shows a block diagram 1200 of a communications manager 1220 that supports communication of system information via a PDSCH in accordance with information provided by a MIB in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of communication of system information via a PDSCH in accordance with information provided by a MIB as described herein. For example, the communications manager 1220 may include a MIB reception component 1225, an SIB reception component 1230, a wireless communication component 1235, or any combination thereof. Each of these components, or components or subcomponents thereof (e.g., one or more processors, one or more memories), may communicate, directly or indirectly, with one another (e.g., via one or more buses).

The communications manager 1220 may support wireless communication in accordance with examples as disclosed herein. The MIB reception component 1225 is capable of, configured to, or operable to support a means for receiving, via a PBCH, a MIB that indicates one or more communication parameters associated with a network entity and that includes an indication of a coding rate of a SIB associated with the network entity. The SIB reception component 1230 is capable of, configured to, or operable to support a means for receiving, via a PDSCH, the SIB in accordance with the coding rate indicated by the MIB.

In some examples, the MIB reception component 1225 is capable of, configured to, or operable to support a means for parsing the MIB in accordance with an SSB multiplexing pattern, where the MIB includes the indication of the coding rate of the SIB in accordance with the SSB multiplexing pattern. In some examples, the SSB multiplexing pattern is associated with a frequency division multiplexing of an SSB and the PDSCH. In some examples, the SIB is received according to a TBS that is in accordance with the coding rate indicated by the MIB and a resource assignment associated with the SIB.

In some examples, receiving the SIB is in accordance with a TDRA associated with the SIB. In some examples, the TDRA is in accordance with a rule indicative of TDRAs for SIBs of which coding rates are indicated by MIBs. In some examples, the TDRA associated with the SIB corresponds to one of a first set of symbols occupied by an SSB that includes the MIB in accordance with the rule; or a second set of symbols associated with a fixed offset from the first set of symbols occupied by the SSB that includes the MIB in accordance with the rule. In some examples, the TDRA associated with the SIB corresponds to a first set of symbols occupied by an SSB that includes the MIB and a second set of symbols associated with a fixed offset from the first set of symbols in accordance with the rule. In some examples, the fixed offset is associated with an index of the SSB that includes the MIB.

In some examples, the MIB reception component 1225 is capable of, configured to, or operable to support a means for receiving, via the MIB, information indicative of a TDRA associated with the SIB, where the SIB is received in accordance with the TDRA indicated by the MIB. In some examples, a starting symbol of the TDRA corresponds to an initial symbol of a first set of symbols occupied by an SSB that includes the MIB or is associated with a fixed offset from the initial symbol of the first set of symbols. In some examples, the information indicative of the TDRA indicates a quantity of symbols from the starting symbol, the TDRA including the quantity of symbols from the starting symbol.

In some examples, the information indicative of the TDRA indicates the quantity of symbols by indicating a first value or a second value. In some examples, the first value corresponds to a first quantity of symbols and the second value corresponds to a second quantity of symbols. In some examples, a first set of symbols of the TDRA corresponds to a set of symbols occupied by an SSB that includes the MIB or is associated with a fixed offset from the set of symbols occupied by the SSB. In some examples, the information indicative of the TDRA indicates whether the TDRA additionally includes a second set of symbols. In some examples, the information indicative of the TDRA indicates whether the TDRA additionally includes the second set of symbols by indicating a first value or a second value. In some examples, the first value corresponds to the TDRA additionally including the second set of symbols and the second value corresponds to the TDRA excluding the second set of symbols.

In some examples, a TDRA associated with the SIB includes a first set of symbols and a second set of symbols. In some examples, the first set of symbols includes a first DMRS symbol and the second set of symbols includes a second DMRS symbol; or the first set of symbols includes the first DMRS symbol and the second set of symbols includes exclusively data symbols.

In some examples, a TDRA associated with the SIB includes a first set of symbols and a second set of symbols. In some examples, the first set of symbols is associated with a first set of bits from a circular buffer corresponding to the SIB and the second set of symbols is associated with a second set of bits from the circular buffer corresponding to the SIB. In some examples, the first set of bits and the second set of bits are consecutive sets of bits from the circular buffer from a starting position corresponding to a single RV associated with the circular buffer; or the first set of bits and the second set of bits are non-consecutive sets of bits from the circular buffer from different starting positions corresponding to different RVs associated with the circular buffer, a first starting bit of the first set of bits corresponding to a first RV and a second starting bit of the second set of bits corresponding to a second RV.

In some examples, receiving the SIB is in accordance with an FDRA associated with the SIB. In some examples, the FDRA is in accordance with a rule indicative of FDRAs for SIBs of which coding rates are indicated by MIBs. In some examples, the FDRA associated with the SIB includes an entirety of a frequency range associated with an initial control resource set or an initial downlink BWP indicated by the MIB in accordance with the rule. In some examples, the MIB reception component 1225 is capable of, configured to, or operable to support a means for receiving, via the MIB, information indicative of an FDRA associated with the SIB, where the SIB is received in accordance with the FDRA indicated by the MIB. In some examples, the information indicative of the FDRA indicates a set of RBs by indicating a first value or a second value. In some examples, the first value corresponds to a first set of RBs and the second value corresponds to a second set of RBs.

In some examples, an FDRA associated with the SIB is associated with a set of VRBs. In some examples, the FDRA is associated with a fixed mapping between the set of VRBs and a set of PRBs in accordance with a rule indicative of FDRAs for SIBs of which coding rates are indicated by MIBs; or the MIB indicates a mapping between the set of VRBs and the set of PRBs.

In some examples, an RV associated with the SIB is in accordance with one or more of a system frame number, a subframe index within a frame, a slot index, or a starting symbol index associated with the PDSCH via which the SIB is received. In some examples, the RV is from a set of multiple available RVs that is defined in accordance with a rule indicative of available RVs for SIBs of which coding rates are indicated by MIBs; or indicated by the MIB. In some examples, the MIB indicates a first value corresponding to a first set of available RVs or a second value corresponding to a second set of available RVs.

In some examples, the SIB is present within the PDSCH in accordance with an absence of a downlink control information message scheduling a PDSCH transmission or a physical uplink shared channel transmission that overlaps with a resource assignment associated with the SIB; a detection of a DMRS associated with a sequence that corresponds to the SIB within the PDSCH; or an indication in the MIB indicating that the SIB is present within the PDSCH.

In some examples, the wireless communication component 1235 is capable of, configured to, or operable to support a means for performing wireless communication with the network entity in accordance with the one or more communication parameters indicated by the MIB and one or more system information parameters indicated by the SIB. In some examples, the UE receives the SIB via the PDSCH without receiving a control message via a PDCCH that schedules the SIB. In some examples, the SIB includes or is SIB1. In some examples, the PDSCH includes an RMSI PDSCH. In some examples, the one or more communication parameters indicated by the MIB include one or more of an SFN, an SCS, an SSB subcarrier offset, a DMRS position, a cell barred indication, and an intra-frequency reselection indication.

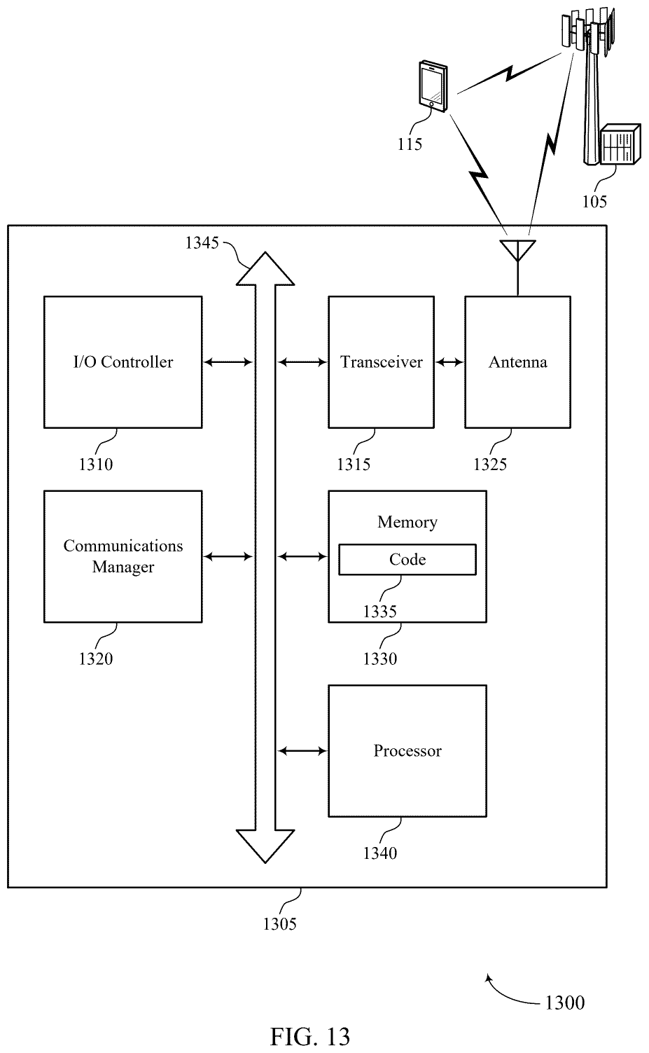

FIG. 13 shows a diagram of a system 1300 including a device 1305 that supports communication of system information via a PDSCH in accordance with information provided by a MIB in accordance with one or more aspects of the present disclosure. The device 1305 may be an example of or include components of a device 1005, a device 1105, or a UE 115 as described herein. The device 1305 may communicate (e.g., wirelessly) with one or more other devices (e.g., network entities 105, UEs 115, or a combination thereof). The device 1305 may include components for bi-directional voice and data communications including components for transmitting and receiving communications, such as a communications manager 1320, an input/output (I/O) controller, such as an I/O controller 1310, a transceiver 1315, one or more antennas 1325, at least one memory 1330, code 1335, and at least one processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of one or more processors, such as the at least one processor 1340. In some cases, a user may interact with the device 1305 via the I/O controller 1310 or via hardware components controlled by the I/O controller 1310.

In some cases, the device 1305 may include a single antenna. However, in some other cases, the device 1305 may have more than one antenna, which may be capable of concurrently transmitting or receiving multiple wireless transmissions. The transceiver 1315 may communicate bi-directionally via the one or more antennas 1325 using wired or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The at least one memory 1330 may include random access memory (RAM) and read-only memory (ROM). The at least one memory 1330 may store computer-readable, computer-executable, or processor-executable code, such as the code 1335. The code 1335 may include instructions that, when executed by the at least one processor 1340, cause the device 1305 to perform various functions described herein. The code 1335 may be stored in a non-transitory computer-readable medium such as system memory or another type of memory. In some cases, the code 1335 may not be directly executable by the at least one processor 1340 but may cause a computer (e.g., when compiled and executed) to perform functions described herein. In some cases, the at least one memory 1330 may include, among other things, a basic I/O system (BIOS) which may control basic hardware or software operation such as the interaction with peripheral components or devices.

The at least one processor 1340 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1340 may be configured to operate a memory array using a memory controller. In some other cases, a memory controller may be integrated into the at least one processor 1340. The at least one processor 1340 may be configured to execute computer-readable instructions stored in a memory (e.g., the at least one memory 1330) to cause the device 1305 to perform various functions (e.g., functions or tasks supporting communication of system information via a PDSCH in accordance with information provided by a MIB). For example, the device 1305 or a component of the device 1305 may include at least one processor 1340 and at least one memory 1330 coupled with or to the at least one processor 1340, the at least one processor 1340 and the at least one memory 1330 configured to perform various functions described herein.

In some examples, the at least one processor 1340 may include multiple processors and the at least one memory 1330 may include multiple memories. One or more of the multiple processors may be coupled with one or more of the multiple memories, which may, individually or collectively, be configured to perform various functions described herein. In some examples, the at least one processor 1340 may be a component of a processing system, which may refer to a system (such as a series) of machines, circuitry (including, for example, one or both of processor circuitry (which may include the at least one processor 1340) and memory circuitry (which may include the at least one memory 1330)), or components, that receives or obtains inputs and processes the inputs to produce, generate, or obtain a set of outputs. The processing system may be configured to perform one or more of the functions described herein. For example, the at least one processor 1340 or a processing system including the at least one processor 1340 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code 1335 (e.g., processor-executable code) stored in the at least one memory 1330 or otherwise, to perform one or more of the functions described herein.

The communications manager 1320 may support wireless communication in accordance with examples as disclosed herein. For example, the communications manager 1320 is capable of, configured to, or operable to support a means for receiving, via a PBCH, a MIB that indicates one or more communication parameters associated with a network entity and that includes an indication of a coding rate of a SIB associated with the network entity. The communications manager 1320 is capable of, configured to, or operable to support a means for receiving, via a PDSCH, the SIB in accordance with the coding rate indicated by the MIB.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the at least one processor 1340, the at least one memory 1330, the code 1335, or any combination thereof. For example, the code 1335 may include instructions executable by the at least one processor 1340 to cause the device 1305 to perform various aspects of communication of system information via a PDSCH in accordance with information provided by a MIB as described herein, or the at least one processor 1340 and the at least one memory 1330 may be otherwise configured to, individually or collectively, perform or support such operations.

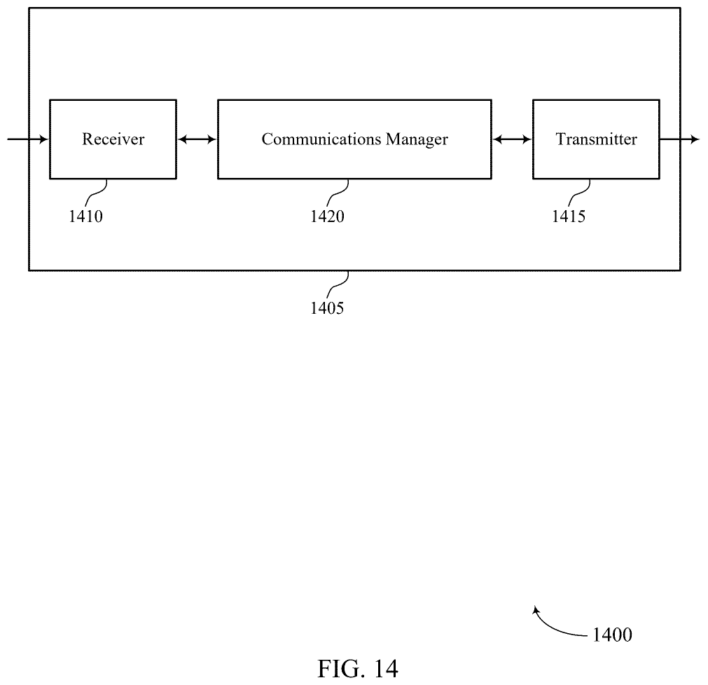

FIG. 14 shows a block diagram 1400 of a device 1405 that supports communication of system information via a PDSCH in accordance with information provided by a MIB in accordance with one or more aspects of the present disclosure. The device 1405 may be an example of aspects of a network entity 105 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to, individually or collectively, support or enable the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The communications manager 1420, the receiver 1410, the transmitter 1415, or various combinations or components thereof may be examples of means for performing various aspects of communication of system information via a PDSCH in accordance with information provided by a MIB as described herein. For example, the communications manager 1420, the receiver 1410, the transmitter 1415, or various combinations or components thereof may be capable of performing one or more of the functions described herein.

In some examples, the communications manager 1420, the receiver 1410, the transmitter 1415, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1420, the receiver 1410, the transmitter 1415, or various combinations or components thereof may be implemented in code (e.g., as communications management software or firmware) executed by at least one processor (e.g., referred to as a processor-executable code). If implemented in code executed by at least one processor, the functions of the communications manager 1420, the receiver 1410, the transmitter 1415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication in accordance with examples as disclosed herein. For example, the communications manager 1420 is capable of, configured to, or operable to support a means for outputting, via a PBCH, a MIB that indicates one or more communication parameters associated with the network entity and that includes an indication of a coding rate of a SIB associated with the network entity. The communications manager 1420 is capable of, configured to, or operable to support a means for outputting, via a PDSCH, the SIB in accordance with the coding rate indicated by the MIB.

By including or configuring the communications manager 1420 in accordance with examples as described herein, the device 1405 (e.g., at least one processor controlling or otherwise coupled with the receiver 1410, the transmitter 1415, the communications manager 1420, or a combination thereof) may support techniques for reduced processing, reduced power consumption, and more efficient utilization of communication resources.

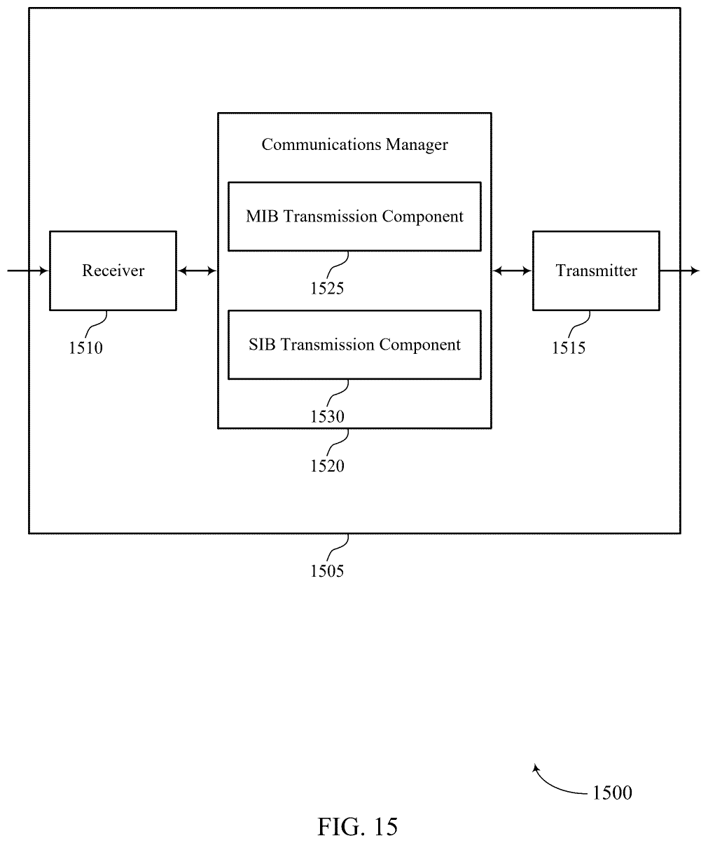

FIG. 15 shows a block diagram 1500 of a device 1505 that supports communication of system information via a PDSCH in accordance with information provided by a MIB in accordance with one or more aspects of the present disclosure. The device 1505 may be an example of aspects of a device 1405 or a network entity 105 as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to support the described techniques. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The device 1505, or various components thereof, may be an example of means for performing various aspects of communication of system information via a PDSCH in accordance with information provided by a MIB as described herein. For example, the communications manager 1520 may include a MIB transmission component 1525 an SIB transmission component 1530, or any combination thereof. The communications manager 1520 may be an example of aspects of a communications manager 1420 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communication in accordance with examples as disclosed herein. The MIB transmission component 1525 is capable of, configured to, or operable to support a means for outputting, via a PBCH, a MIB that indicates one or more communication parameters associated with the network entity and that includes an indication of a coding rate of a SIB associated with the network entity. The SIB transmission component 1530 is capable of, configured to, or operable to support a means for outputting, via a PDSCH, the SIB in accordance with the coding rate indicated by the MIB.

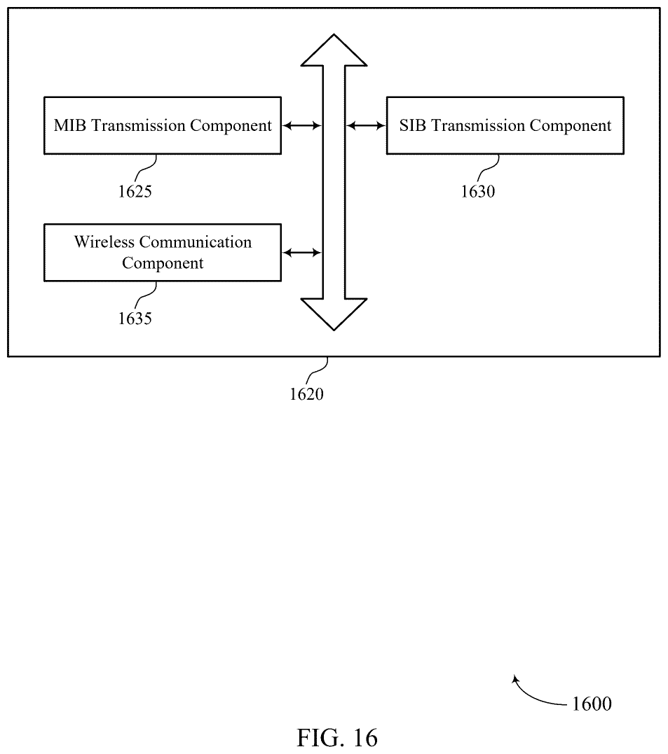

FIG. 16 shows a block diagram 1600 of a communications manager 1620 that supports communication of system information via a PDSCH in accordance with information provided by a MIB in accordance with one or more aspects of the present disclosure. The communications manager 1620 may be an example of aspects of a communications manager 1420, a communications manager 1520, or both, as described herein. The communications manager 1620, or various components thereof, may be an example of means for performing various aspects of communication of system information via a PDSCH in accordance with information provided by a MIB as described herein. For example, the communications manager 1620 may include a MIB transmission component 1625, an SIB transmission component 1630, a wireless communication component 1635, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.gpu

The communications manager 1620 may support wireless communication in accordance with examples as disclosed herein. The MIB transmission component 1625 is capable of, configured to, or operable to support a means for outputting, via a PBCH, a MIB that indicates one or more communication parameters associated with the network entity and that includes an indication of a coding rate of a SIB associated with the network entity. The SIB transmission component 1630 is capable of, configured to, or operable to support a means for outputting, via a PDSCH, the SIB in accordance with the coding rate indicated by the MIB. In some examples, the indication of the coding rate of the SIB is included in the MIB in accordance with an SSB multiplexing pattern. In some examples, the SSB multiplexing pattern is associated with a frequency division multiplexing of an SSB and the PDSCH. In some examples, the SIB is output according to a TBS that is in accordance with the coding rate indicated by the MIB and a resource assignment associated with the SIB.

In some examples, outputting the SIB is in accordance with a TDRA associated with the SIB. In some examples, the TDRA is in accordance with a rule indicative of TDRAs for SIBs of which coding rates are indicated by MIBs. In some examples, the TDRA associated with the SIB corresponds to one of a first set of symbols occupied by an SSB that includes the MIB in accordance with the rule; or a second set of symbols associated with a fixed offset from the first set of symbols occupied by the SSB that includes the MIB in accordance with the rule. In some examples, the TDRA associated with the SIB corresponds to a first set of symbols occupied by an SSB that includes the MIB and a second set of symbols associated with a fixed offset from the first set of symbols in accordance with the rule. In some examples, the fixed offset is associated with an index of the SSB that includes the MIB.

In some examples, the MIB transmission component 1625 is capable of, configured to, or operable to support a means for outputting, via the MIB, information indicative of a TDRA associated with the SIB, where the SIB is output in accordance with the TDRA indicated by the MIB. In some examples, a starting symbol of the TDRA corresponds to an initial symbol of a first set of symbols occupied by an SSB that includes the MIB or is associated with a fixed offset from the initial symbol of the first set of symbols. In some examples, the information indicative of the TDRA indicates a quantity of symbols from the starting symbol, the TDRA including the quantity of symbols from the starting symbol.

In some examples, the information indicative of the TDRA indicates the quantity of symbols by indicating a first value or a second value. In some examples, the first value corresponds to a first quantity of symbols and the second value corresponds to a second quantity of symbols. In some examples, a first set of symbols of the TDRA corresponds to a set of symbols occupied by an SSB that includes the MIB or is associated with a fixed offset from the set of symbols occupied by the SSB. In some examples, the information indicative of the TDRA indicates whether the TDRA additionally includes a second set of symbols.

In some examples, the information indicative of the TDRA indicates whether the TDRA additionally includes the second set of symbols by indicating a first value or a second value. In some examples, the first value corresponds to the TDRA additionally including the second set of symbols and the second value corresponds to the TDRA excluding the second set of symbols. In some examples, a TDRA associated with the SIB includes a first set of symbols and a second set of symbols. In some examples, the first set of symbols includes a first DMRS symbol and the second set of symbols includes a second DMRS symbol; or the first set of symbols includes the first DMRS symbol and the second set of symbols includes exclusively data symbols.

In some examples, a TDRA associated with the SIB includes a first set of symbols and a second set of symbols. In some examples, the first set of symbols is associated with a first set of bits from a circular buffer corresponding to the SIB and the second set of symbols is associated with a second set of bits from the circular buffer corresponding to the SIB. In some examples, the first set of bits and the second set of bits are consecutive sets of bits from the circular buffer from a starting position corresponding to a single RV associated with the circular buffer; or the first set of bits and the second set of bits are non-consecutive sets of bits from the circular buffer from different starting positions corresponding to different RVs associated with the circular buffer, a first starting bit of the first set of bits corresponding to a first RV and a second starting bit of the second set of bits corresponding to a second RV.

In some examples, outputting the SIB is in accordance with an FDRA associated with the SIB. In some examples, the FDRA is in accordance with a rule indicative of FDRAs for SIBs of which coding rates are indicated by MIBs. In some examples, the FDRA associated with the SIB includes an entirety of a frequency range associated with an initial control resource set or an initial downlink BWP indicated by the MIB in accordance with the rule. In some examples, the MIB transmission component 1625 is capable of, configured to, or operable to support a means for outputting, via the MIB, information indicative of an FDRA associated with the SIB, where the SIB is output in accordance with the FDRA indicated by the MIB.

In some examples, the information indicative of the FDRA indicates a set of RBs by indicating a first value or a second value. In some examples, the first value corresponds to a first set of RBs and the second value corresponds to a second set of RBs. In some examples, an FDRA associated with the SIB is associated with a set of VRBs. In some examples, the FDRA is associated with a fixed mapping between the set of VRBs and a set of PRBs in accordance with a rule indicative of FDRAs for SIBs of which coding rates are indicated by MIBs; or the MIB indicates a mapping between the set of VRBs and the set of PRBs.

In some examples, an RV associated with the SIB is in accordance with one or more of a system frame number, a subframe index within a frame, a slot index, or a starting symbol index associated with the PDSCH via which the SIB is output. In some examples, the RV is from a set of multiple available RVs that is defined in accordance with a rule indicative of available RVs for SIBs of which coding rates are indicated by MIBs; or indicated by the MIB. In some examples, the MIB indicates a first value corresponding to a first set of available RVs or a second value corresponding to a second set of available RVs.

In some examples, the SIB is present within the PDSCH in accordance with an absence of a downlink control information message scheduling a PDSCH transmission or a physical uplink shared channel transmission that overlaps with a resource assignment associated with the SIB; a presence of a DMRS associated with a sequence that corresponds to the SIB within the PDSCH; or an indication in the MIB indicating that the SIB is present within the PDSCH.

In some examples, the wireless communication component 1635 is capable of, configured to, or operable to support a means for performing wireless communication in accordance with the one or more communication parameters indicated by the MIB and one or more system information parameters indicated by the SIB. In some examples, the network entity outputs the SIB via the PDSCH without outputting a control message via a PDCCH that schedules the SIB. In some examples, the SIB includes or is SIB1. In some examples, the PDSCH includes a RMSI PDSCH. In some examples, the one or more communication parameters indicated by the MIB include one or more of an SFN, an SCS, an SSB subcarrier offset, a DMRS position, a cell barred indication, and an intra-frequency reselection indication.

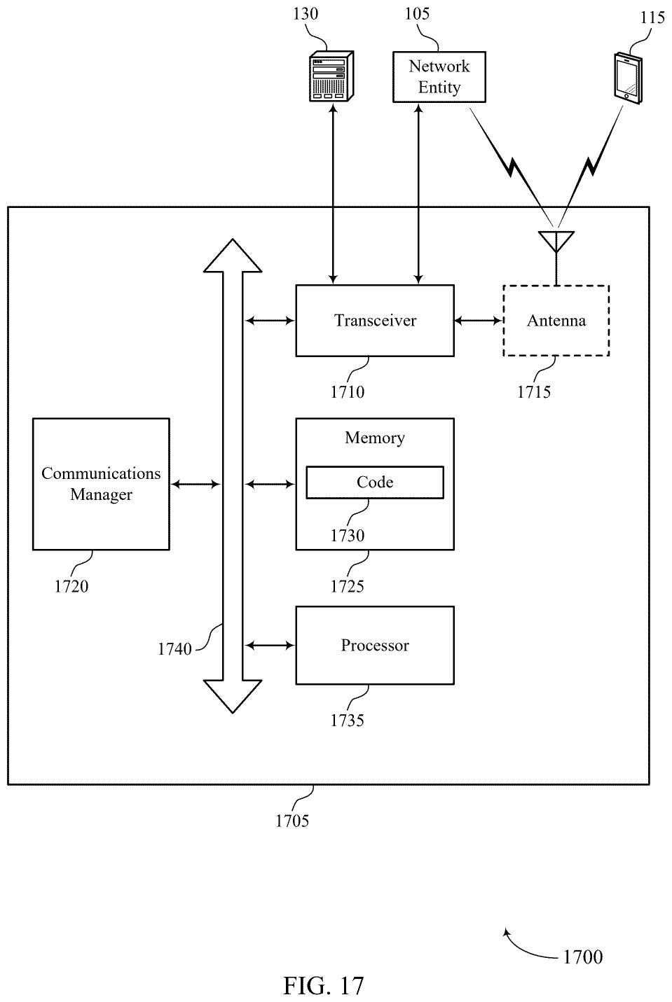

FIG. 17 shows a diagram of a system 1700 including a device 1705 that supports communication of system information via a PDSCH in accordance with information provided by a MIB in accordance with one or more aspects of the present disclosure. The device 1705 may be an example of or include components of a device 1405, a device 1505, or a network entity 105 as described herein. The device 1705 may communicate with other network devices or network equipment such as one or more of the network entities 105, UEs 115, or any combination thereof. The communications may include communications over one or more wired interfaces, over one or more wireless interfaces, or any combination thereof. The device 1705 may include components that support outputting and obtaining communications, such as a communications manager 1720, a transceiver 1710, one or more antennas 1715, at least one memory 1725, code 1730, and at least one processor 1735. These components may be in electronic communication or otherwise coupled (e.g., operatively, communicatively, functionally, electronically, electrically) via one or more buses (e.g., a bus 1740).

The transceiver 1710 may support bi-directional communications via wired links, wireless links, or both as described herein. In some examples, the transceiver 1710 may include a wired transceiver and may communicate bi-directionally with another wired transceiver. Additionally, or alternatively, in some examples, the transceiver 1710 may include a wireless transceiver and may communicate bi-directionally with another wireless transceiver. In some examples, the device 1705 may include one or more antennas 1715, which may be capable of transmitting or receiving wireless transmissions (e.g., concurrently). The transceiver 1710 may also include a modem to modulate signals, to provide the modulated signals for transmission (e.g., by one or more antennas 1715, by a wired transmitter), to receive modulated signals (e.g., from one or more antennas 1715, from a wired receiver), and to demodulate signals. In some implementations, the transceiver 1710 may include one or more interfaces, such as one or more interfaces coupled with the one or more antennas 1715 that are configured to support various receiving or obtaining operations, or one or more interfaces coupled with the one or more antennas 1715 that are configured to support various transmitting or outputting operations, or a combination thereof. In some implementations, the transceiver 1710 may include or be configured for coupling with one or more processors or one or more memory components that are operable to perform or support operations based on received or obtained information or signals, or to generate information or other signals for transmission or other outputting, or any combination thereof. In some implementations, the transceiver 1710, or the transceiver 1710 and the one or more antennas 1715, or the transceiver 1710 and the one or more antennas 1715 and one or more processors or one or more memory components (e.g., the at least one processor 1735, the at least one memory 1725, or both), may be included in a chip or chip assembly that is installed in the device 1705. In some examples, the transceiver 1710 may be operable to support communications via one or more communications links (e.g., communication link(s) 125, backhaul communication link(s) 120, a midhaul communication link 162, a fronthaul communication link 168).

The at least one memory 1725 may include RAM, ROM, or any combination thereof. The at least one memory 1725 may store computer-readable, computer-executable, or processor-executable code, such as the code 1730. The code 1730 may include instructions that, when executed by one or more of the at least one processor 1735, cause the device 1705 to perform various functions described herein. The code 1730 may be stored in a non-transitory computer-readable medium such as system memory or another type of memory. In some cases, the code 1730 may not be directly executable by a processor of the at least one processor 1735 but may cause a computer (e.g., when compiled and executed) to perform functions described herein. In some cases, the at least one memory 1725 may include, among other things, a BIOS which may control basic hardware or software operation such as the interaction with peripheral components or devices. In some examples, the at least one processor 1735 may include multiple processors and the at least one memory 1725 may include multiple memories. One or more of the multiple processors may be coupled with one or more of the multiple memories which may, individually or collectively, be configured to perform various functions herein (for example, as part of a processing system).

The at least one processor 1735 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1735 may be configured to operate a memory array using a memory controller. In some other cases, a memory controller may be integrated into one or more of the at least one processor 1735. The at least one processor 1735 may be configured to execute computer-readable instructions stored in a memory (e.g., one or more of the at least one memory 1725) to cause the device 1705 to perform various functions (e.g., functions or tasks supporting communication of system information via a PDSCH in accordance with information provided by a MIB). For example, the device 1705 or a component of the device 1705 may include at least one processor 1735 and at least one memory 1725 coupled with one or more of the at least one processor 1735, the at least one processor 1735 and the at least one memory 1725 configured to perform various functions described herein. The at least one processor 1735 may be an example of a cloud-computing platform (e.g., one or more physical nodes and supporting software such as operating systems, virtual machines, or container instances) that may host the functions (e.g., by executing code 1730) to perform the functions of the device 1705. The at least one processor 1735 may be any one or more suitable processors capable of executing scripts or instructions of one or more software programs stored in the device 1705 (such as within one or more of the at least one memory 1725).

In some examples, the at least one processor 1735 may include multiple processors and the at least one memory 1725 may include multiple memories. One or more of the multiple processors may be coupled with one or more of the multiple memories, which may, individually or collectively, be configured to perform various functions herein. In some examples, the at least one processor 1735 may be a component of a processing system, which may refer to a system (such as a series) of machines, circuitry (including, for example, one or both of processor circuitry (which may include the at least one processor 1735) and memory circuitry (which may include the at least one memory 1725)), or components, that receives or obtains inputs and processes the inputs to produce, generate, or obtain a set of outputs. The processing system may be configured to perform one or more of the functions described herein. For example, the at least one processor 1735 or a processing system including the at least one processor 1735 may be configured to, configurable to, or operable to cause the device 1705 to perform one or more of the functions described herein. Further, as described herein, being “configured to,” being “configurable to,” and being “operable to” may be used interchangeably and may be associated with a capability, when executing code stored in the at least one memory 1725 or otherwise, to perform one or more of the functions described herein.

In some examples, a bus 1740 may support communications of (e.g., within) a protocol layer of a protocol stack. In some examples, a bus 1740 may support communications associated with a logical channel of a protocol stack (e.g., between protocol layers of a protocol stack), which may include communications performed within a component of the device 1705, or between different components of the device 1705 that may be co-located or located in different locations (e.g., where the device 1705 may refer to a system in which one or more of the communications manager 1720, the transceiver 1710, the at least one memory 1725, the code 1730, and the at least one processor 1735 may be located in one of the different components or divided between different components).

In some examples, the communications manager 1720 may manage aspects of communications with a core network 130 (e.g., via one or more wired or wireless backhaul links). For example, the communications manager 1720 may manage the transfer of data communications for client devices, such as one or more UEs 115. In some examples, the communications manager 1720 may manage communications with one or more other network entities 105, and may include a controller or scheduler for controlling communications with UEs 115 (e.g., in cooperation with the one or more other network devices). In some examples, the communications manager 1720 may support an X2 interface within an LTE/LTE-A wireless communications network technology to provide communication between network entities 105.

The communications manager 1720 may support wireless communication in accordance with examples as disclosed herein. For example, the communications manager 1720 is capable of, configured to, or operable to support a means for outputting, via a PBCH, a MIB that indicates one or more communication parameters associated with the network entity and that includes an indication of a coding rate of a SIB associated with the network entity. The communications manager 1720 is capable of, configured to, or operable to support a means for outputting, via a PDSCH, the SIB in accordance with the coding rate indicated by the MIB.

By including or configuring the communications manager 1720 in accordance with examples as described herein, the device 1705 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1720 may be configured to perform various operations (e.g., receiving, obtaining, monitoring, outputting, transmitting) using or otherwise in cooperation with the transceiver 1710, the one or more antennas 1715 (e.g., where applicable), or any combination thereof. Although the communications manager 1720 is illustrated as a separate component, in some examples, one or more functions described with reference to the communications manager 1720 may be supported by or performed by the transceiver 1710, one or more of the at least one processor 1735, one or more of the at least one memory 1725, the code 1730, or any combination thereof (for example, by a processing system including at least a portion of the at least one processor 1735, the at least one memory 1725, the code 1730, or any combination thereof). For example, the code 1730 may include instructions executable by one or more of the at least one processor 1735 to cause the device 1705 to perform various aspects of communication of system information via a PDSCH in accordance with information provided by a MIB as described herein, or the at least one processor 1735 and the at least one memory 1725 may be otherwise configured to, individually or collectively, perform or support such operations.

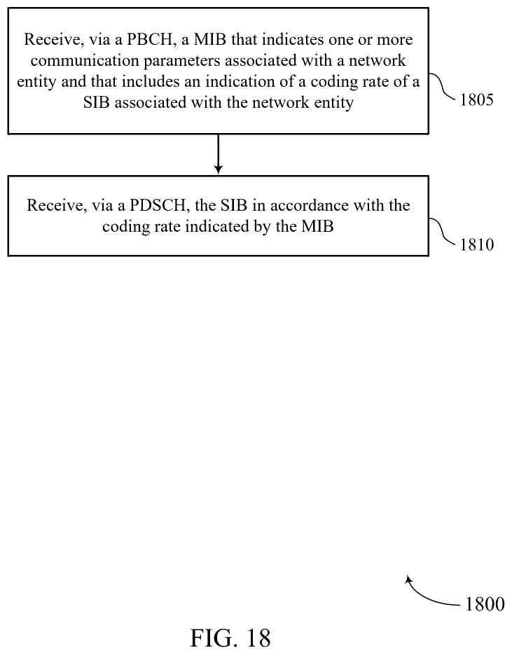

FIG. 18 shows a flowchart illustrating a method 1800 that supports communication of system information via a PDSCH in accordance with information provided by a MIB in accordance with one or more aspects of the present disclosure. The operations of the method 1800 may be implemented by a UE or its components as described herein. For example, the operations of the method 1800 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1805, the method may include receiving, via a PBCH, a MIB that indicates one or more communication parameters associated with a network entity and that includes an indication of a coding rate of a SIB associated with the network entity. The operations of 1805 may be performed in accordance with examples as disclosed herein. In some examples, aspects of the operations of 1805 may be performed by a MIB reception component 1225 as described with reference to FIG. 12.

At 1810, the method may include receiving, via a PDSCH, the SIB in accordance with the coding rate indicated by the MIB. The operations of 1810 may be performed in accordance with examples as disclosed herein. In some examples, aspects of the operations of 1810 may be performed by an SIB reception component 1230 as described with reference to FIG. 12.

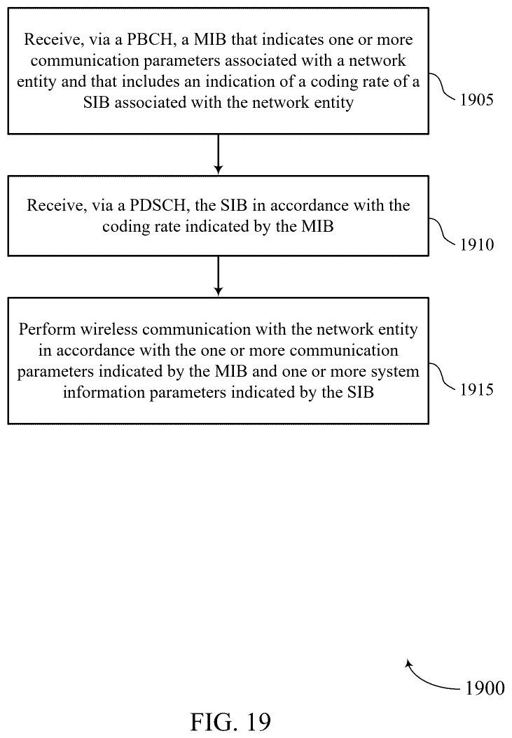

FIG. 19 shows a flowchart illustrating a method 1900 that supports communication of system information via a PDSCH in accordance with information provided by a MIB in accordance with one or more aspects of the present disclosure. The operations of the method 1900 may be implemented by a UE or its components as described herein. For example, the operations of the method 1900 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1905, the method may include receiving, via a PBCH, a MIB that indicates one or more communication parameters associated with a network entity and that includes an indication of a coding rate of a SIB associated with the network entity. The operations of 1905 may be performed in accordance with examples as disclosed herein. In some examples, aspects of the operations of 1905 may be performed by a MIB reception component 1225 as described with reference to FIG. 12.

At 1910, the method may include receiving, via a PDSCH, the SIB in accordance with the coding rate indicated by the MIB. The operations of 1910 may be performed in accordance with examples as disclosed herein. In some examples, aspects of the operations of 1910 may be performed by an SIB reception component 1230 as described with reference to FIG. 12.

At 1915, the method may include performing wireless communication with the network entity in accordance with the one or more communication parameters indicated by the MIB and one or more system information parameters indicated by the SIB. The operations of 1915 may be performed in accordance with examples as disclosed herein. In some examples, aspects of the operations of 1915 may be performed by a wireless communication component 1235 as described with reference to FIG. 12.

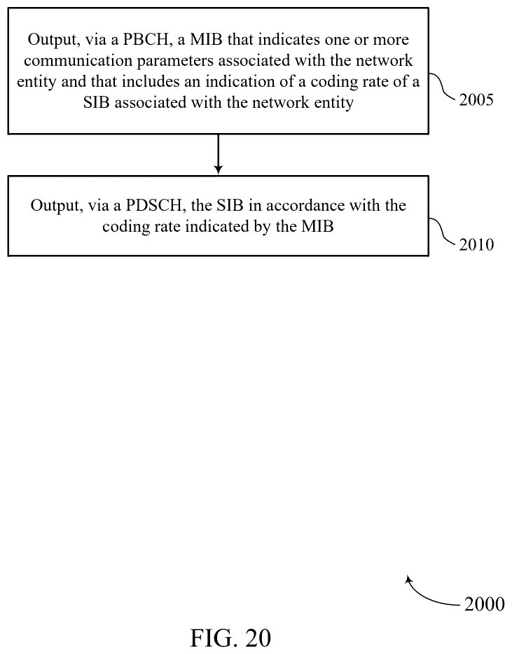

FIG. 20 shows a flowchart illustrating a method 2000 that supports communication of system information via a PDSCH in accordance with information provided by a MIB in accordance with one or more aspects of the present disclosure. The operations of the method 2000 may be implemented by a network entity or its components as described herein. For example, the operations of the method 2000 may be performed by a network entity as described with reference to FIGS. 1 through 8 and 14 through 17. In some examples, a network entity may execute a set of instructions to control the functional elements of the network entity to perform the described functions. Additionally, or alternatively, the network entity may perform aspects of the described functions using special-purpose hardware.

At 2005, the method may include outputting, via a PBCH, a MIB that indicates one or more communication parameters associated with the network entity and that includes an indication of a coding rate of a SIB associated with the network entity. The operations of 2005 may be performed in accordance with examples as disclosed herein. In some examples, aspects of the operations of 2005 may be performed by a MIB transmission component 1625 as described with reference to FIG. 16.

At 2010, the method may include outputting, via a PDSCH, the SIB in accordance with the coding rate indicated by the MIB. The operations of 2010 may be performed in accordance with examples as disclosed herein. In some examples, aspects of the operations of 2010 may be performed by an SIB transmission component 1630 as described with reference to FIG. 16.

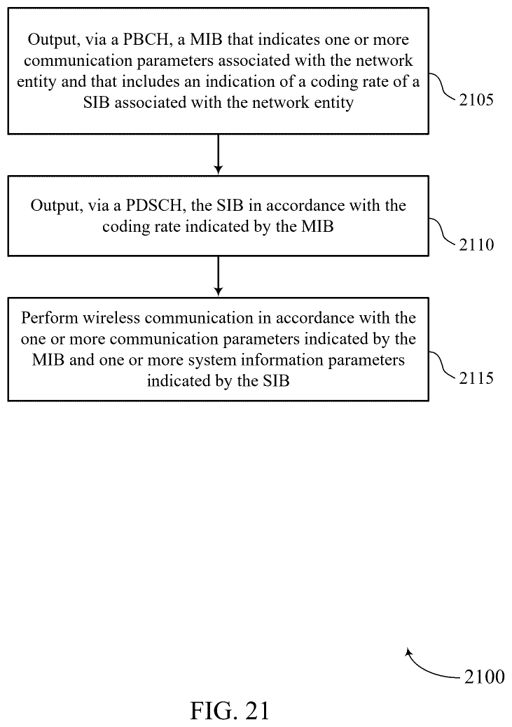

FIG. 21 shows a flowchart illustrating a method 2100 that supports communication of system information via a PDSCH in accordance with information provided by a MIB in accordance with one or more aspects of the present disclosure. The operations of the method 2100 may be implemented by a network entity or its components as described herein. For example, the operations of the method 2100 may be performed by a network entity as described with reference to FIGS. 1 through 8 and 14 through 17. In some examples, a network entity may execute a set of instructions to control the functional elements of the network entity to perform the described functions. Additionally, or alternatively, the network entity may perform aspects of the described functions using special-purpose hardware.

At 2105, the method may include outputting, via a PBCH, a MIB that indicates one or more communication parameters associated with the network entity and that includes an indication of a coding rate of a SIB associated with the network entity. The operations of 2105 may be performed in accordance with examples as disclosed herein. In some examples, aspects of the operations of 2105 may be performed by a MIB transmission component 1625 as described with reference to FIG. 16.

At 2110, the method may include outputting, via a PDSCH, the SIB in accordance with the coding rate indicated by the MIB. The operations of 2110 may be performed in accordance with examples as disclosed herein. In some examples, aspects of the operations of 2110 may be performed by an SIB transmission component 1630 as described with reference to FIG. 16.

At 2115, the method may include performing wireless communication in accordance with the one or more communication parameters indicated by the MIB and one or more system information parameters indicated by the SIB. The operations of 2115 may be performed in accordance with examples as disclosed herein. In some examples, aspects of the operations of 2115 may be performed by a wireless communication component 1635 as described with reference to FIG. 16.

The following provides an overview of aspects of the present disclosure:
Aspect 1: A method for wireless communication at a UE, comprising: receiving, via a PBCH, a MIB that indicates one or more communication parameters associated with a network entity and that includes an indication of a coding rate of a SIB associated with the network entity; and receiving, via a PDSCH, the SIB in accordance with the coding rate indicated by the MIB.
Aspect 2: The method of aspect 1, further comprising: parsing the MIB in accordance with an SSB multiplexing pattern, wherein the MIB includes the indication of the coding rate of the SIB in accordance with the SSB multiplexing pattern.
Aspect 3: The method of aspect 2, wherein the SSB multiplexing pattern is associated with an FDM of an SSB and the PDSCH.
Aspect 4: The method of any of aspects 1-3, wherein the SIB is received according to a TBS that is in accordance with the coding rate indicated by the MIB and a resource assignment associated with the SIB.
Aspect 5: The method of any of aspects 1-4, wherein receiving the SIB is in accordance with a TDRA associated with the SIB, and the TDRA is in accordance with a rule indicative of TDRAs for SIBs of which coding rates are indicated by MIBs.
Aspect 6: The method of aspect 5, wherein the TDRA associated with the SIB corresponds to one of a first set of symbols occupied by an SSB that includes the MIB in accordance with the rule; or a second set of symbols associated with a fixed offset from the first set of symbols occupied by the SSB that includes the MIB in accordance with the rule.
Aspect 7: The method of any of aspects 5-6, wherein the TDRA associated with the SIB corresponds to a first set of symbols occupied by an SSB that includes the MIB and a second set of symbols associated with a fixed offset from the first set of symbols in accordance with the rule.
Aspect 8: The method of aspect 7, wherein the fixed offset is associated with an index of the SSB that includes the MIB.
Aspect 9: The method of any of aspects 1-8, further comprising: receiving, via the MIB, information indicative of a TDRA associated with the SIB, wherein the SIB is received in accordance with the TDRA indicated by the MIB.
Aspect 10: The method of aspect 9, wherein a starting symbol of the TDRA corresponds to an initial symbol of a first set of symbols occupied by an SSB that includes the MIB or is associated with a fixed offset from the initial symbol of the first set of symbols; and the information indicative of the TDRA indicates a quantity of symbols from the starting symbol, the TDRA including the quantity of symbols from the starting symbol.
Aspect 11: The method of aspect 10, wherein the information indicative of the TDRA indicates the quantity of symbols by indicating a first value or a second value, and the first value corresponds to a first quantity of symbols and the second value corresponds to a second quantity of symbols.
Aspect 12: The method of any of aspects 9-11, wherein a first set of symbols of the TDRA corresponds to a set of symbols occupied by an SSB that includes the MIB or is associated with a fixed offset from the set of symbols occupied by the SSB; and the information indicative of the TDRA indicates whether the TDRA additionally includes a second set of symbols.
Aspect 13: The method of aspect 12, wherein the information indicative of the TDRA indicates whether the TDRA additionally includes the second set of symbols by indicating a first value or a second value, and the first value corresponds to the TDRA additionally including the second set of symbols and the second value corresponds to the TDRA excluding the second set of symbols.
Aspect 14: The method of any of aspects 1-13, wherein a TDRA associated with the SIB includes a first set of symbols and a second set of symbols, and wherein: the first set of symbols includes a first DMRS symbol and the second set of symbols includes a second DMRS symbol; or the first set of symbols includes the first DMRS symbol and the second set of symbols includes exclusively data symbols.
Aspect 15: The method of any of aspects 1-14, wherein a TDRA associated with the SIB includes a first set of symbols and a second set of symbols, wherein the first set of symbols is associated with a first set of bits from a circular buffer corresponding to the SIB and the second set of symbols is associated with a second set of bits from the circular buffer corresponding to the SIB, and wherein: the first set of bits and the second set of bits are consecutive sets of bits from the circular buffer from a starting position corresponding to a single RV associated with the circular buffer; or the first set of bits and the second set of bits are non-consecutive sets of bits from the circular buffer from different starting positions corresponding to different RVs associated with the circular buffer, a first starting bit of the first set of bits corresponding to a first RV and a second starting bit of the second set of bits corresponding to a second RV.
Aspect 16: The method of any of aspects 1-15, wherein receiving the SIB is in accordance with an FDRA associated with the SIB, the FDRA is in accordance with a rule indicative of FDRAs for SIBs of which coding rates are indicated by MIBs.
Aspect 17: The method of aspect 16, wherein the FDRA associated with the SIB includes an entirety of a frequency range associated with an initial CORESET or an initial downlink BWP indicated by the MIB in accordance with the rule.
Aspect 18: The method of any of aspects 1-17, further comprising: receiving, via the MIB, information indicative of an FDRA associated with the SIB, wherein the SIB is received in accordance with the FDRA indicated by the MIB.
Aspect 19: The method of aspect 18, wherein the information indicative of the FDRA indicates a set of RBs by indicating a first value or a second value, and the first value corresponds to a first set of RBs and the second value corresponds to a second set of RBs.
Aspect 20: The method of any of aspects 1-19, wherein an FDRA associated with the SIB is associated with a set of VRBs, and wherein: the FDRA is associated with a fixed mapping between the set of VRBs and a set of PRBs in accordance with a rule indicative of FDRAs for SIBs of which coding rates are indicated by MIBs; or the MIB indicates a mapping between the set of VRBs and the set of PRBs.
Aspect 21: The method of any of aspects 1-20, wherein an RV associated with the SIB is in accordance with one or more of an SFN, a subframe index within a frame, a slot index, or a starting symbol index associated with the PDSCH via which the SIB is received, wherein the RV is from a plurality of available RVs that is: defined in accordance with a rule indicative of available RVs for SIBs of which coding rates are indicated by MIBs; or indicated by the MIB, the MIB indicating a first value corresponding to a first set of available RVs or a second value corresponding to a second set of available RVs.
Aspect 22: The method of any of aspects 1-21, wherein the SIB is present within the PDSCH in accordance with: an absence of a DCI message scheduling a PDSCH transmission or a PUSCH transmission that overlaps with a resource assignment associated with the SIB; a detection of a DMRS associated with a sequence that corresponds to the SIB within the PDSCH; or an indication in the MIB indicating that the SIB is present within the PDSCH.
Aspect 23: The method of any of aspects 1-22, further comprising: performing wireless communication with the network entity in accordance with the one or more communication parameters indicated by the MIB and one or more system information parameters indicated by the SIB.
Aspect 24: The method of any of aspects 1-23, wherein the UE receives the SIB via the PDSCH without receiving a control message via a PDCCH that schedules the SIB.
Aspect 25: The method of any of aspects 1-24, wherein the SIB comprises SIB1, and the PDSCH comprises an RMSI PDSCH.
Aspect 26: The method of any of aspects 1-25, wherein the one or more communication parameters indicated by the MIB comprise one or more of an SFN, an SCS, an SSB subcarrier offset, a DMRS position, a cell barred indication, and an intra-frequency reselection indication.
Aspect 27: A method for wireless communication at a network entity, comprising: outputting, via a PBCH, a MIB that indicates one or more communication parameters associated with the network entity and that includes an indication of a coding rate of a SIB associated with the network entity; and outputting, via a PDSCH, the SIB in accordance with the coding rate indicated by the MIB.
Aspect 28: The method of aspect 27, wherein the indication of the coding rate of the SIB is included in the MIB in accordance with an SSB multiplexing pattern, the SSB multiplexing pattern is associated with an FDM of an SSB and the PDSCH.
Aspect 29: The method of any of aspects 27-28, wherein the SIB is output according to a TBS that is in accordance with the coding rate indicated by the MIB and a resource assignment associated with the SIB.
Aspect 30: The method of any of aspects 27-29, wherein outputting the SIB is in accordance with a TDRA associated with the SIB, and the TDRA is in accordance with a rule indicative of TDRAs for SIBs of which coding rates are indicated by MIBs.
Aspect 31: The method of aspect 30, wherein the TDRA associated with the SIB corresponds to one of a first set of symbols occupied by an SSB that includes the MIB in accordance with the rule; or a second set of symbols associated with a fixed offset from the first set of symbols occupied by the SSB that includes the MIB in accordance with the rule.
Aspect 32: The method of any of aspects 30-31, wherein the TDRA associated with the SIB corresponds to a first set of symbols occupied by an SSB that includes the MIB and a second set of symbols associated with a fixed offset from the first set of symbols in accordance with the rule.
Aspect 33: The method of aspect 32, wherein the fixed offset is associated with an index of the SSB that includes the MIB.
Aspect 34: The method of any of aspects 27-33, further comprising: outputting, via the MIB, information indicative of a TDRA associated with the SIB, wherein the SIB is output in accordance with the TDRA indicated by the MIB.
Aspect 35: The method of aspect 34, wherein a starting symbol of the TDRA corresponds to an initial symbol of a first set of symbols occupied by an SSB that includes the MIB or is associated with a fixed offset from the initial symbol of the first set of symbols, and the information indicative of the TDRA indicates a quantity of symbols from the starting symbol, the TDRA including the quantity of symbols from the starting symbol.
Aspect 36: The method of aspect 35, wherein the information indicative of the TDRA indicates the quantity of symbols by indicating a first value or a second value, and the first value corresponds to a first quantity of symbols and the second value corresponds to a second quantity of symbols.
Aspect 37: The method of any of aspects 34-36, wherein a first set of symbols of the TDRA corresponds to a set of symbols occupied by an SSB that includes the MIB or is associated with a fixed offset from the set of symbols occupied by the SSB, and the information indicative of the TDRA indicates whether the TDRA additionally includes a second set of symbols.
Aspect 38: The method of aspect 37, wherein the information indicative of the TDRA indicates whether the TDRA additionally includes the second set of symbols by indicating a first value or a second value, and the first value corresponds to the TDRA additionally including the second set of symbols and the second value corresponds to the TDRA excluding the second set of symbols.
Aspect 39: The method of any of aspects 27-38, wherein a TDRA associated with the SIB includes a first set of symbols and a second set of symbols, and wherein: the first set of symbols includes a first DMRS symbol and the second set of symbols includes a second DMRS symbol; or the first set of symbols includes the first DMRS symbol and the second set of symbols includes exclusively data symbols.
Aspect 40: The method of any of aspects 27-39, wherein a TDRA associated with the SIB includes a first set of symbols and a second set of symbols, the first set of symbols is associated with a first set of bits from a circular buffer corresponding to the SIB and the second set of symbols is associated with a second set of bits from the circular buffer corresponding to the SIB, and the first set of bits and the second set of bits are consecutive sets of bits from the circular buffer from a starting position corresponding to a single RV associated with the circular buffer; or the first set of bits and the second set of bits are non-consecutive sets of bits from the circular buffer from different starting positions corresponding to different RVs associated with the circular buffer, a first starting bit of the first set of bits corresponding to a first RV and a second starting bit of the second set of bits corresponding to a second RV.
Aspect 41: The method of any of aspects 27-40, wherein outputting the SIB is in accordance with an FDRA associated with the SIB, and the FDRA is in accordance with a rule indicative of FDRAs for SIBs of which coding rates are indicated by MIBs.
Aspect 42: The method of aspect 41, wherein the FDRA associated with the SIB includes an entirety of a frequency range associated with an initial CORESET or an initial downlink BWP indicated by the MIB in accordance with the rule.
Aspect 43: The method of any of aspects 27-42, further comprising: outputting, via the MIB, information indicative of an FDRA associated with the SIB, wherein the SIB is output in accordance with the FDRA indicated by the MIB.
Aspect 44: The method of aspect 43, wherein the information indicative of the FDRA indicates a set of RBs by indicating a first value or a second value, and the first value corresponds to a first set of RBs and the second value corresponds to a second set of RBs.
Aspect 45: The method of any of aspects 27-44, wherein an FDRA associated with the SIB is associated with a set of VRBs, and wherein: the FDRA is associated with a fixed mapping between the set of VRBs and a set of PRBs in accordance with a rule indicative of FDRAs for SIBs of which coding rates are indicated by MIBs; or the MIB indicates a mapping between the set of VRBs and the set of PRBs.
Aspect 46: The method of any of aspects 27-45, wherein an RV associated with the SIB is in accordance with one or more of an SFN, a subframe index within a frame, a slot index, or a starting symbol index associated with the PDSCH via which the SIB is output, and wherein the RV is from a plurality of available RVs that is: defined in accordance with a rule indicative of available RVs for SIBs of which coding rates are indicated by MIBs; or indicated by the MIB, the MIB indicates a first value corresponding to a first set of available RVs or a second value corresponding to a second set of available RVs.
Aspect 47: The method of any of aspects 27-46, wherein the SIB is present within the PDSCH in accordance with: an absence of a DCI message scheduling a PDSCH transmission or a PUSCH transmission that overlaps with a resource assignment associated with the SIB; a presence of a DMRS associated with a sequence that corresponds to the SIB within the PDSCH; or an indication in the MIB indicating that the SIB is present within the PDSCH.
Aspect 48: The method of any of aspects 27-47, further comprising: performing wireless communication in accordance with the one or more communication parameters indicated by the MIB and one or more system information parameters indicated by the SIB.
Aspect 49: The method of any of aspects 27-48, wherein the network entity outputs the SIB via the PDSCH without outputting a control message via a PDCCH that schedules the SIB.
Aspect 50: The method of any of aspects 27-49, wherein the SIB comprises SIB1, and the PDSCH comprises an RMSI PDSCH.
Aspect 51: The method of any of aspects 27-50, wherein the one or more communication parameters indicated by the MIB comprise one or more of an SFN, an SCS, an SSB subcarrier offset, a DMRS position, a cell barred indication, and an intra-frequency reselection indication.
Aspect 52: A UE for wireless communication, comprising one or more memories storing processor-executable code, and one or more processors coupled with the one or more memories and individually or collectively operable to execute the code to cause the UE to perform a method of any of aspects 1-26.
Aspect 53: A UE for wireless communication, comprising at least one means for performing a method of any of aspects 1-26.
Aspect 54: A non-transitory computer-readable medium storing code for wireless communication, the code comprising instructions executable by one or more processors to perform a method of any of aspects 1-26.
Aspect 55: A network entity for wireless communication, comprising one or more memories storing processor-executable code, and one or more processors coupled with the one or more memories and individually or collectively operable to execute the code to cause the network entity to perform a method of any of aspects 27-51.
Aspect 56: A network entity for wireless communication, comprising at least one means for performing a method of any of aspects 27-51.
Aspect 57: A non-transitory computer-readable medium storing code for wireless communication, the code comprising instructions executable by one or more processors to perform a method of any of aspects 27-51.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, via a physical broadcast channel, a master information block that indicates one or more communication parameters associated with a network entity and that includes an indication of a coding rate of a system information block associated with the network entity; and
receive, via a physical downlink shared channel, the system information block in accordance with the coding rate indicated by the master information block.

2. The UE of claim 1, wherein the one or more processors are individually or collectively further operable to execute the code to cause the UE to:
parse the master information block in accordance with a synchronization signal block multiplexing pattern, wherein the master information block includes the indication of the coding rate of the system information block in accordance with the synchronization signal block multiplexing pattern, and wherein the synchronization signal block multiplexing pattern is associated with a frequency division multiplexing of a synchronization signal block and the physical downlink shared channel.

3. The UE of claim 1, wherein:
receiving the system information block is in accordance with a time domain resource assignment associated with the system information block; and
the time domain resource assignment is in accordance with a rule indicative of time domain resource assignments for system information blocks of which coding rates are indicated by master information blocks.

4. The UE of claim 3, wherein the time domain resource assignment associated with the system information block corresponds to one of:
a first set of symbols occupied by a synchronization signal block that includes the master information block in accordance with the rule; or
a second set of symbols associated with a fixed offset from the first set of symbols occupied by the synchronization signal block that includes the master information block in accordance with the rule.

5. The UE of claim 3, wherein the time domain resource assignment associated with the system information block corresponds to:
a first set of symbols occupied by a synchronization signal block that includes the master information block; and
a second set of symbols associated with a fixed offset from the first set of symbols in accordance with the rule.

6. The UE of claim 5, wherein the fixed offset is associated with an index of the synchronization signal block that includes the master information block.

7. The UE of claim 1, wherein the one or more processors are individually or collectively further operable to execute the code to cause the UE to:
receive, via the master information block, information indicative of a time domain resource assignment associated with the system information block, wherein the system information block is received in accordance with the time domain resource assignment indicated by the master information block.

8. The UE of claim 7, wherein:
a starting symbol of the time domain resource assignment corresponds to an initial symbol of a first set of symbols occupied by a synchronization signal block that includes the master information block or is associated with a fixed offset from the initial symbol of the first set of symbols; and
the information indicative of the time domain resource assignment indicates a quantity of symbols from the starting symbol, the time domain resource assignment including the quantity of symbols from the starting symbol.

9. The UE of claim 8, wherein:
the information indicative of the time domain resource assignment indicates the quantity of symbols by indicating a first value or a second value; and
the first value corresponds to a first quantity of symbols and the second value corresponds to a second quantity of symbols.

10. The UE of claim 7, wherein:
a first set of symbols of the time domain resource assignment corresponds to a set of symbols occupied by a synchronization signal block that includes the master information block or is associated with a fixed offset from the set of symbols occupied by the synchronization signal block; and
the information indicative of the time domain resource assignment indicates whether the time domain resource assignment additionally includes a second set of symbols.

11. The UE of claim 10, wherein:
the information indicative of the time domain resource assignment indicates whether the time domain resource assignment additionally includes the second set of symbols by indicating a first value or a second value; and
the first value corresponds to the time domain resource assignment additionally including the second set of symbols and the second value corresponds to the time domain resource assignment excluding the second set of symbols.

12. The UE of claim 1, wherein:
receiving the system information block is in accordance with a frequency domain resource assignment associated with the system information block; and
the frequency domain resource assignment is in accordance with a rule indicative of frequency domain resource assignments for system information blocks of which coding rates are indicated by master information blocks.

13. The UE of claim 12, wherein the frequency domain resource assignment associated with the system information block includes an entirety of a frequency range associated with an initial control resource set or an initial downlink bandwidth part indicated by the master information block in accordance with the rule.

14. The UE of claim 1, wherein the one or more processors are individually or collectively further operable to execute the code to cause the UE to:
receive, via the master information block, information indicative of a frequency domain resource assignment associated with the system information block, wherein the system information block is received in accordance with the frequency domain resource assignment indicated by the master information block.

15. The UE of claim 14, wherein:
the information indicative of the frequency domain resource assignment indicates a set of resource blocks by indicating a first value or a second value; and
the first value corresponds to a first set of resource blocks and the second value corresponds to a second set of resource blocks.

16. The UE of claim 1, wherein the one or more processors are individually or collectively further operable to execute the code to cause the UE to:
perform wireless communication with the network entity in accordance with the one or more communication parameters indicated by the master information block and one or more system information parameters indicated by the system information block.

17. The UE of claim 1, wherein the UE receives the system information block via the physical downlink shared channel without receiving a control message via a physical downlink control channel that schedules the system information block.

18. A network entity, comprising:
one or more memories storing processor-executable code; and
one or more processors coupled with the one or more memories and individually or collectively operable to execute the code to cause the network entity to:
output, via a physical broadcast channel, a master information block that indicates one or more communication parameters associated with the network entity and that includes an indication of a coding rate of a system information block associated with the network entity; and
output, via a physical downlink shared channel, the system information block in accordance with the coding rate indicated by the master information block.

19. The network entity of claim 18, wherein:
the indication of the coding rate of the system information block is included in the master information block in accordance with a synchronization signal block multiplexing pattern; and
the synchronization signal block multiplexing pattern is associated with a frequency division multiplexing of a synchronization signal block and the physical downlink shared channel.

20. The network entity of claim 18, wherein a time domain resource assignment associated with the system information block includes a first set of symbols and a second set of symbols, and wherein:
the first set of symbols includes a first demodulation reference signal symbol and the second set of symbols includes a second demodulation reference signal symbol; or
the first set of symbols includes the first demodulation reference signal symbol and the second set of symbols includes exclusively data symbols.

21. The network entity of claim 18, wherein a time domain resource assignment associated with the system information block includes a first set of symbols and a second set of symbols, wherein the first set of symbols is associated with a first set of bits from a circular buffer corresponding to the system information block and the second set of symbols is associated with a second set of bits from the circular buffer corresponding to the system information block, and wherein:
the first set of bits and the second set of bits are consecutive sets of bits from the circular buffer from a starting position corresponding to a single redundancy version associated with the circular buffer; or
the first set of bits and the second set of bits are non-consecutive sets of bits from the circular buffer from different starting positions corresponding to different redundancy versions associated with the circular buffer, a first starting bit of the first set of bits corresponding to a first redundancy version and a second starting bit of the second set of bits corresponding to a second redundancy version.

22. The network entity of claim 18, wherein a frequency domain resource assignment associated with the system information block is associated with a set of virtual resource blocks, and wherein:
the frequency domain resource assignment is associated with a fixed mapping between the set of virtual resource blocks and a set of physical resource blocks in accordance with a rule indicative of frequency domain resource assignments for system information blocks of which coding rates are indicated by master information blocks; or
the master information block indicates a mapping between the set of virtual resource blocks and the set of physical resource blocks.

23. The network entity of claim 18, wherein a redundancy version associated with the system information block is in accordance with one or more of a system frame number, a subframe index within a frame, a slot index, or a starting symbol index associated with the physical downlink shared channel via which the system information block is output, and wherein the redundancy version is from a plurality of available redundancy versions that is:
defined in accordance with a rule indicative of available redundancy versions for system information blocks of which coding rates are indicated by master information blocks; or
indicated by the master information block, wherein the master information block indicates a first value corresponding to a first set of available redundancy versions or a second value corresponding to a second set of available redundancy versions.

24. The network entity of claim 18, wherein the system information block is present within the physical downlink shared channel in accordance with:
an absence of a downlink control information message scheduling a physical downlink shared channel transmission or a physical uplink shared channel transmission that overlaps with a resource assignment associated with the system information block;
a presence of a demodulation reference signal associated with a sequence that corresponds to the system information block within the physical downlink shared channel; or
an indication in the master information block indicating that the system information block is present within the physical downlink shared channel.

25. The network entity of claim 18, wherein the one or more processors are individually or collectively further operable to execute the code to cause the network entity to:
perform wireless communication in accordance with the one or more communication parameters indicated by the master information block and one or more system information parameters indicated by the system information block.

26. The network entity of claim 18, wherein the network entity outputs the system information block via the physical downlink shared channel without outputting a control message via a physical downlink control channel that schedules the system information block.

27. A method for wireless communication at a user equipment (UE), comprising:
receiving, via a physical broadcast channel, a master information block that indicates one or more communication parameters associated with a network entity and that includes an indication of a coding rate of a system information block associated with the network entity; and
receiving, via a physical downlink shared channel, the system information block in accordance with the coding rate indicated by the master information block.

28. The method of claim 27, wherein the system information block is present within the physical downlink shared channel in accordance with:
an absence of a downlink control information message scheduling a physical downlink shared channel transmission or a physical uplink shared channel transmission that overlaps with a resource assignment associated with the system information block;
a detection of a demodulation reference signal associated with a sequence that corresponds to the system information block within the physical downlink shared channel; or
an indication in the master information block indicating that the system information block is present within the physical downlink shared channel.

29. A method for wireless communication at a network entity, comprising:
outputting, via a physical broadcast channel, a master information block that indicates one or more communication parameters associated with the network entity and that includes an indication of a coding rate of a system information block associated with the network entity; and
outputting, via a physical downlink shared channel, the system information block in accordance with the coding rate indicated by the master information block.

30. The method of claim 29, wherein:
the network entity outputs the system information block via the physical downlink shared channel without outputting a control message via a physical downlink control channel that schedules the system information block;
the system information block comprises a first system information block (SIB1);
the physical downlink shared channel comprises a remaining minimum system information physical downlink shared channel; and
the one or more communication parameters indicated by the master information block comprise one or more of a system frame number, a subcarrier spacing, a synchronization signal block subcarrier offset, a demodulation reference signal position, a cell barred indication, and an intra-frequency reselection indication.
